(19) United States
(12) Patent Application Publication
(10) Pub. No.: US 2024/0249237 A1
(43) Pub. Date: Jul. 25, 2024

(54) AIRCRAFT STORAGE MANAGEMENT

(71) Applicant: HangarIT Corporation, Davie, FL (US)

(72) Inventors: Douglas WILSON, Seattle, WA (US); Owen BUSCH, Chelsea, MI (US); Carl HELKA, Fenton, MI (US); Chris SALLEY, Fort Lauderdale, FL (US)

(21) Appl. No.: 18/126,124

(22) Filed: Mar. 24, 2023

Related U.S. Application Data
(60) Provisional application No. 63/440,614, filed on Jan. 23, 2023.

(51) Int. Cl. G06Q 10/087

(52) U.S. Cl. CPC G06Q 10/087; B64F 1/222

(57) ABSTRACT

A method for managing aircraft storage comprises observing an aircraft, identifying the aircraft, identifying a leasehold that can store the aircraft, adding the aircraft to a hangar space in the leasehold, updating a hangar Roll Call, and providing insights and analytics to a fixed base operator. A system for managing aircraft storage comprises a network, one or more local and external data sources or methods configured to provide aircraft data operated or performed by a fixed-base operator or third-party respectively, and an aircraft management server that automatically generates aircraft entries based on the aircraft data. The aircraft management server can also identify one or more aircraft, determine a space in a leasehold capable of holding the aircraft, and assign a Roll Call record for the one or more aircraft. The aircraft entries or Roll Call record are accessible to a user using an electronic device via a user interface.

### CROSS-REFERENCE TO RELATED APPLICATIONS

This application claims the benefit of provisional U.S. Application No. 63/440,614 entitled “Aircraft Storage Management” filed Jan. 23, 2023, the technical disclosure of which is incorporated herein by reference in its entirety.

### BACKGROUND

### Technical Field

Novel aspects of the present disclosure relate to the field of aircraft storage management and more particularly, to a method and system for assigning aircraft to hangar spaces.

### Background

The business and general aviation (B&GA) industry, defined as non-scheduled aircraft operations operating under 14 CFR Part 91 and 135, are served by fixed-base operators (FBOs), which offer aircraft parking and covered storage, refueling, and a host of other services to B&GA customers. FBOs offer both itinerant aircraft parking and covered storage, as well as semi-permanent tenant parking and covered storage. Aircraft operators principally storing their aircraft in an FBO's semi-permanent parking and covered storage are referred to as “Based Tenants,” and that tenancy may be documented through an aircraft storage agreement.

Covered aircraft storage is most often in the form of aircraft hangars. A hangar is a purpose-built facility, constructed with doors both wide and tall enough to accommodate a given aircraft category or size, and capable of housing one or more aircraft. In cases where multiple aircraft are stored in a single hangar, the standard FBO industry nomenclature for such a facility is either a “Common-Storage Hangar” or “Community Hangar.” FBOs may have one or more Common-Storage Hangars on their leaseholds for covered aircraft storage. Hereafter, for the purposes of ease of reading, “Common-Storage Hangar(s)” or “Community Hangar(s)” can be referred to as a “hangar.”

Although an FBO's Based Tenant aircraft may have a preferred parking location within a hangar, transient or overnight aircraft customers (collectively, “Transient Aircraft Operators” (TAOs)) are positioned in the hangar as space is available from time to time. As a result, the parking position for aircraft within a hangar is subject to change as a function of the mix of Based Tenant aircraft, and transient aircraft stored at a given time. Further, when an FBO's Based Tenant aircraft are operating away from their “home base,” the space temporarily vacated by one or more Based Tenants within the hangar is available for transient aircraft storage by the FBO. As a result, a hangar that is otherwise “full” of Based Tenant aircraft, may, within hours, be vacated by those Based Tenant aircraft, and replaced with transient aircraft, until one or more Based Tenant aircraft return.

An FBO must manually confirm how much space is available through a manual observation of a given hangar. Typically, FBOs with multiple Hangars will manually observe the aircraft storage arrangement once a day to determine which Based Tenant and TAO aircraft are stored for nightly hangar billing purposes. A manual observation of the aircraft in the hangar is typically performed nightly, by an employee of the FBO, who records the uniquely identifying aircraft information, inclusive of both aircraft type and aircraft registration number. This information may be recorded manually, in a notebook, or recorded remotely via two-way radio to another employee, on a spreadsheet, or in a similar manual manner. In either case, a physical inspection of each hangar is required to confirm both the aircraft presently stored and then-available space.

Additionally, no technology solution exists to provide aircraft operators a real-time view of the available space or occupancy within an FBO's Hangar. Today, to reserve a hangar space as a TAO at an airport, a TAO must call or email an FBO, and request space. As no real-time hangar occupancy solution exists, TAOs are unable to reserve guaranteed hangar space. Instead, an FBO will customarily place TAOs on a “wait list,” which is not a guarantee of hangar space.

This is conceptually similar to an airline employee flying as a non-revenue passenger (Non-Rev) on an airline flight; that employee is only accommodated if a paying passenger's seat is vacated—a detail not known to an airline until typically 20 minutes prior to departure. Likewise, a hangar fully occupied by an FBO's Based Tenant's aircraft only become available for overnight storage for a TAO if a Based Tenant's aircraft leaves the hangar. TAOs must wait, not unlike a Non-Rev passenger, until the FBO has visually confirmed hangar space is available. Often, this does not occur until the late evening, with the FBO manually observing which aircraft are in the hangar.

### SUMMARY

Novel aspects of the disclosure are directed to a method and system for assigning aircraft to storage spaces and providing real-time occupancy data about aircraft within those spaces. For example, the method may involve observing an aircraft with an aircraft observation method, wherein the aircraft observation method provides observation data, wherein the observation data comprises an aircraft registration number, the date, the time, and the geocode coordinates of the aircraft, identifying an aircraft based on the observation data, identifying a leasehold that can store the identified aircraft, adding an aircraft to a hangar space in the identified leasehold, updating a hangar Roll Call, and providing insights and analytics to a fixed base operator.

For another example, the system may involve a network, one or more local and external data sources or methods configured to provide aircraft data operated or performed by a fixed-base operator or third-party respectively, an aircraft management server that communicates with the network and executes instructions to automatically generate parked aircraft entries based on the aircraft data from the local or external data sources and present the one or more parked aircraft entries in a user interface; and at least one electronic device configured to allow a user to access the user interface.

In yet another example, the system may involve an aircraft management server that uses aircraft data from one or more local or external data sources to identify one or more aircraft, determine a space in a space in a leasehold that is capable of holding the aircraft, assign a Roll Call record for the one or more aircraft, and present the Roll Call record in a user interface; and at least one electronic device configured to allow a user to access the user interface.

Additional novel aspects of the disclosure are directed to a method and system for allowing aircraft operators to search for vacant hangars that are capable of storing the operator's aircraft, wherein the hangar vacancy status is updated in real-time, and then reserve the hangar for later aircraft storage.

Other aspects, embodiments and features of various embodiments will become apparent from the following detailed description of preferred embodiments when considered in conjunction with the accompanying figures. In the figures, each identical, or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention.

### BRIEF DESCRIPTION OF THE FIGURES

The novel features believed characteristic of the claimed invention are set forth in the appended claims. The invention itself, however, as well as a preferred mode of use, further objectives, and advantages thereof, will be best understood by reference to the following detailed description of illustrative embodiments when read in conjunction with the accompanying figures, wherein:

FIG. 1 is a block diagram of a system for managing aircraft storage based on real-time occupancy data according to an illustrative embodiment;

FIG. 2 is a block diagram of a system for managing aircraft storage based on on real-time occupancy data according to another illustrative embodiment;

FIG. 3 is a drawing depicting a flowchart of a process for aircraft storage management according to an illustrative embodiment;

FIG. 4A is a drawing depicting a technique for observing an aircraft by using an equipped ADS-B transponder according to an illustrative embodiment;

FIG. 4B is a drawing depicting a technique for observing an aircraft equipped with a pre-configured code label according to an illustrative embodiment;

FIG. 4C is a drawing depicting a technique for observing an aircraft using a hangar space equipped with an optical character recognition device according to an illustrative embodiment;

FIG. 5A is a drawing of an apparatus with at least one processor capable of executing instructions according to an illustrative embodiment;

FIG. 5B is a drawing of another apparatus with at least one processor capable of executing instructions according to an illustrative embodiment;

FIG. 6 is a flowchart of a process for observing aircraft according to an illustrative embodiment;

FIG. 7 is a flowchart of an aircraft identification process according to an illustrative embodiment;

FIG. 8 is a flowchart of a leasehold improvement identification process according to an illustrative embodiment;

FIG. 9 is a flowchart of a process for adding an aircraft to a hangar space according to an illustrative embodiment;

FIG. 10 is a flowchart of a process for updating a hangar Roll Call according to an illustrative embodiment;

FIG. 11 is an illustration of a hangar at different time stamps according to an illustrative embodiment;

FIG. 12 is a top-down perspective diagram of a hangar with multiple parked aircraft according to an illustrative embodiment;

FIG. 13 is an illustration of a map of an airport with various leaseholds according to an illustrative embodiment;

FIG. 14 is an illustration of a map of an example leasehold at an airport with multiple improvements according to an illustrative embodiment;

FIG. 15 is an illustration of a sample user interface displaying Roll Call data shown to a fixed base operator according to an illustrative embodiment;

FIG. 16 is an illustration of a sample user interface displaying insights and analytics for aircraft in a hangar space according to an illustrative embodiment;

FIG. 17 is a block diagram of a system for reserving a hangar space based on real-time hangar availability according to another illustrative embodiment; and

FIG. 18 is an illustration of a sample user interface displaying a hangar space reservation process according to an illustrative embodiment.

### DETAILED DESCRIPTION

Today, in the B&GA industry, no technology solution exists to provide FBOs a real-time view of the available space or occupancy within their hangars. Likewise, no technology solution exists to provide aircraft operators a real-time view of the available space or occupancy within an FBO's hangar.

Though many FBOs use closed circuit camera systems within their hangars, these cameras are principally used for security or post-accident investigative purposes, as opposed to real-time tracking of aircraft positioned within the hangar. Although Optical Character Recognition (OCR) technology is available for camera systems, the physical positioning of aircraft within a hangar often blocks the view of an aircraft's registration number or is unable to read aircraft registration numbers due to a host of factors, such as an aircraft's paint scheme. FBOs also use other technology applications to determine the relative location of an inbound or outbound aircraft—either based tenant or transient—through free or paid subscriptions to Automatic Dependent Surveillance-Broadcast (ADS-B) data. ADS-B is a radio signal broadcast by aircraft flying within the national airspace system, used for identification purposes, and radar separation when under positive control by an Air Traffic Control facility. However, none of the present systems as implemented provide a real-time view or can predict through historical data, an FBO's hangar occupancy, or availability.

There are other asset tracking technologies that convert asset location or status to digital data as an alternative to manual observation, but each of these technologies have limitations and trade-offs with no single method being sufficient to produce all necessary observations at any given time. Therefore, a multi-factor approach, described below, for observing, documenting, and identifying unique aircraft parked within a specific hangar, or space, is needed. The approach produces an accurate, aggregate view of all parked aircraft within a hangar at any given time and the resulting, combined single-repository of data is input for a real-time and predictive calculation of hangar occupancy, vacancy, and overall aircraft parking availability.

Operationally, aircraft hangar composition is constantly changing as aircraft are pulled out and new aircraft are parked within a hangar. This disclosure provides examples of methods for managing aircraft storage that may include the data wrangling, contextualization, and calculations necessary to produce an accurate, aggregate view of all parked aircraft within a hangar at any given time.

This description, with references to the figures, presents non-limiting examples of embodiments of the present disclosure. The various embodiments of the presently disclosed subject matter are described with specificity to meet statutory requirements. However, the description itself is not intended to limit the scope of this patent. Rather, it has been contemplated that the claimed subject matter might also be embodied in other ways, to include different steps or elements similar to the ones described in this document, in conjunction with other present or future technologies. The components described hereinafter as making up various elements of the disclosure are intended to be illustrative and not restrictive. Many suitable components that would perform the same or similar functions as the components described herein are intended to be embraced within the scope of the invention. Such other components not described herein can include, but are not limited to, for example, similar components that are developed after development of the presently disclosed subject matter.

It should also be noted that, as used in the specification and the appended claims, the singular forms “a,” “an,” and “the” include plural references unless the context clearly dictates otherwise. References to a composition containing “a” constituent is intended to include other constituents in addition to the one named. Also, in describing the preferred embodiments, terminology will be used for the sake of clarity. It is intended that each term contemplates its broadest meaning as understood by those skilled in the art and includes all technical equivalents, which operate in a similar manner to accomplish a similar purpose.

The use of terms herein such as “having,” “has,” “including,” or “includes” are open-ended and are intended to have the same meaning as terms such as “comprising” or “comprises” and do not preclude the presence of other structure, material, or acts. Similarly, though the use of terms such as “can” or “may” is intended to be open-ended and to reflect that structure, material, or acts are not necessary, the failure to use such terms is not intended to reflect that structure, material, or acts are essential. To the extent that structure, material, or acts are presently considered to be essential, they are identified as such.

Further, the use of the term “hangar” or “hangar space” should be broadly interpreted to mean “improvement” unless the context demands an interpretation that the hangar or hangar space is a physical building with specific dimensions.

It is also to be understood that the mention of one or more method steps does not preclude the presence of additional method steps or intervening method steps between those steps expressly identified. Moreover, although the term “step” may be used herein to connote different aspects of methods employed, the term should not be interpreted as implying any particular order, among or between various steps herein disclosed unless and except when the order of individual steps is explicitly required.

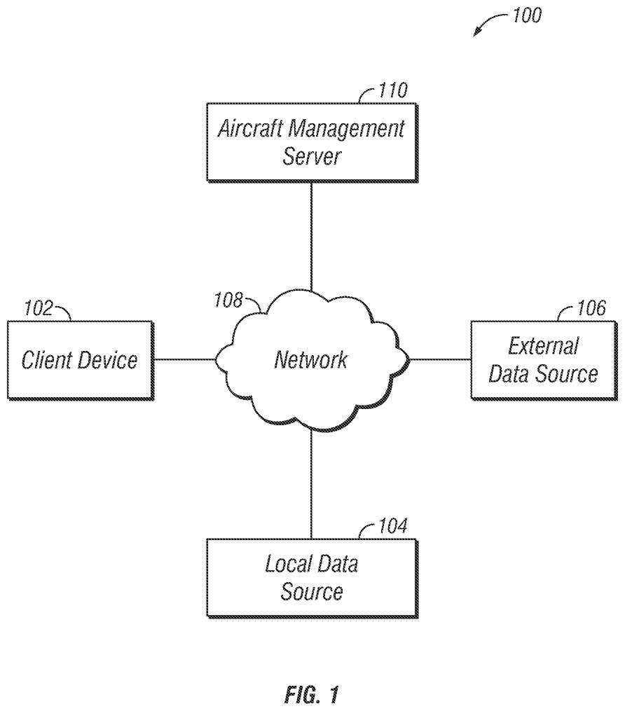

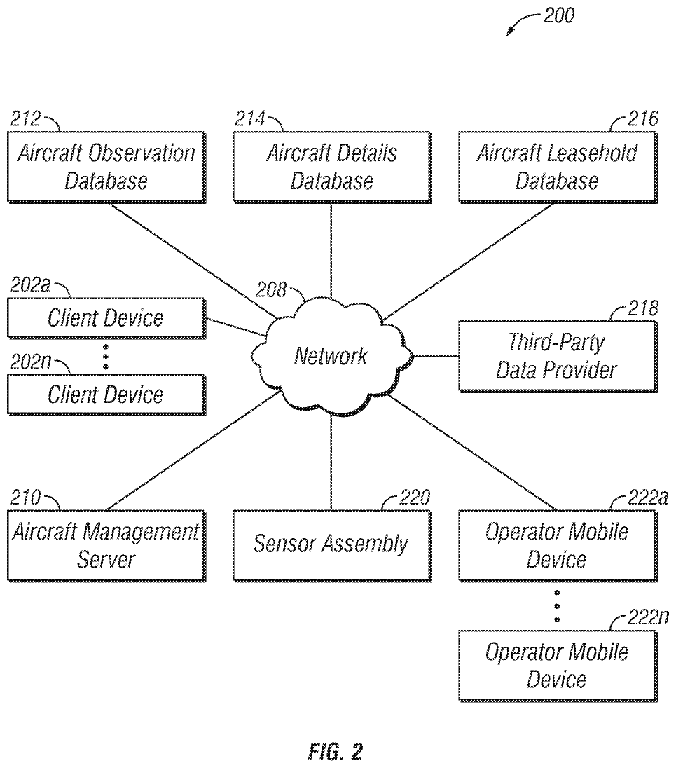

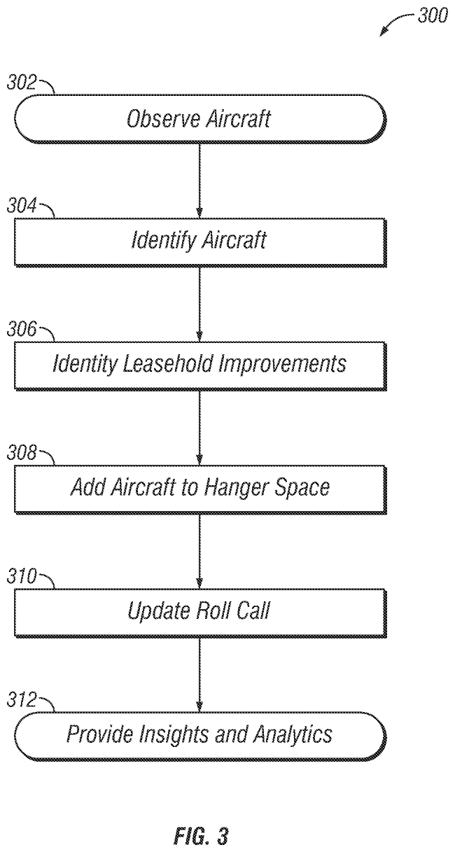

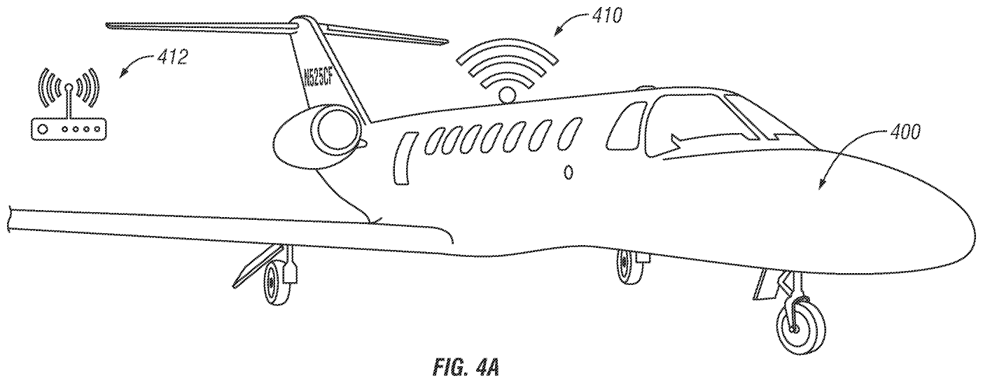

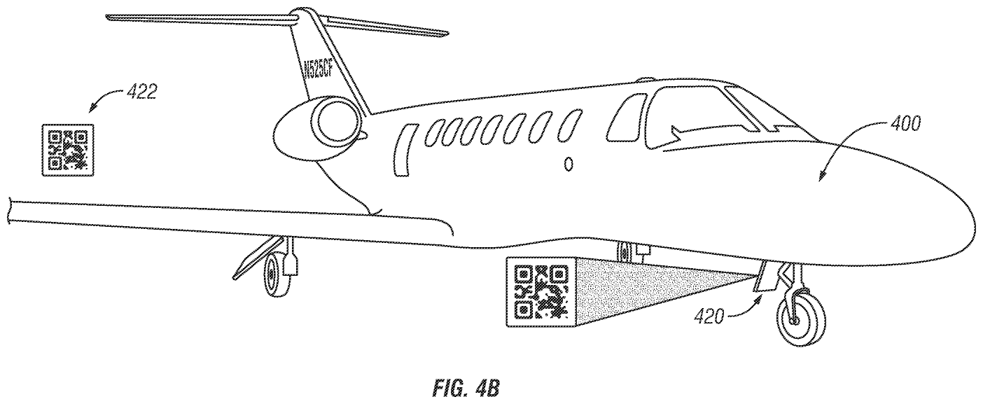

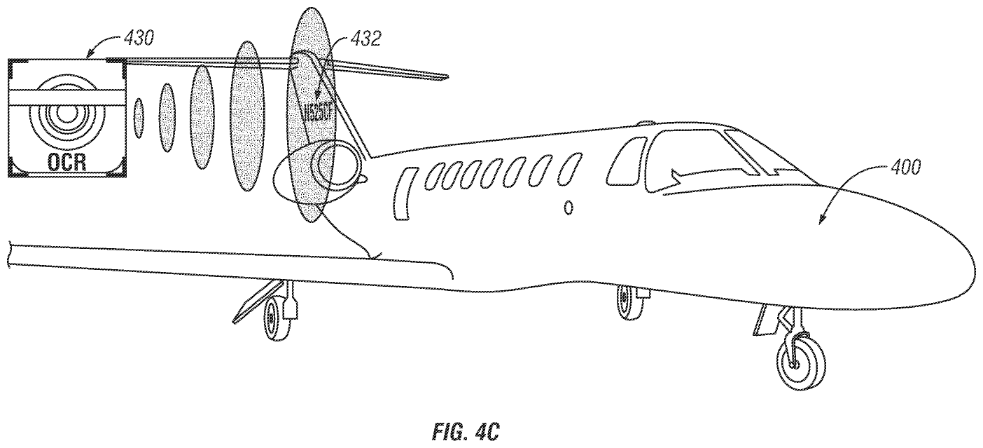

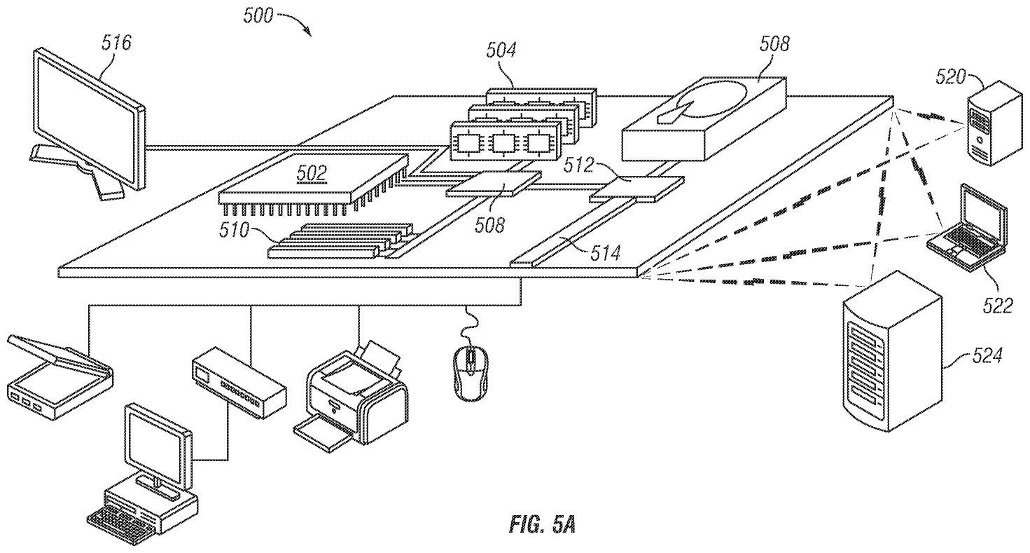

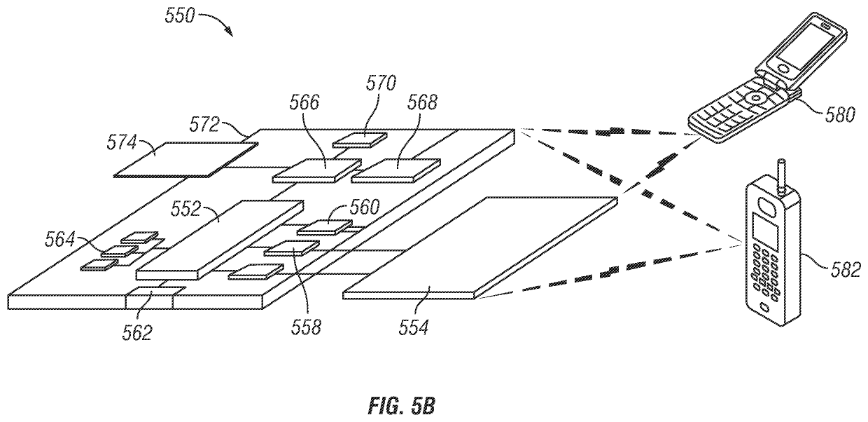

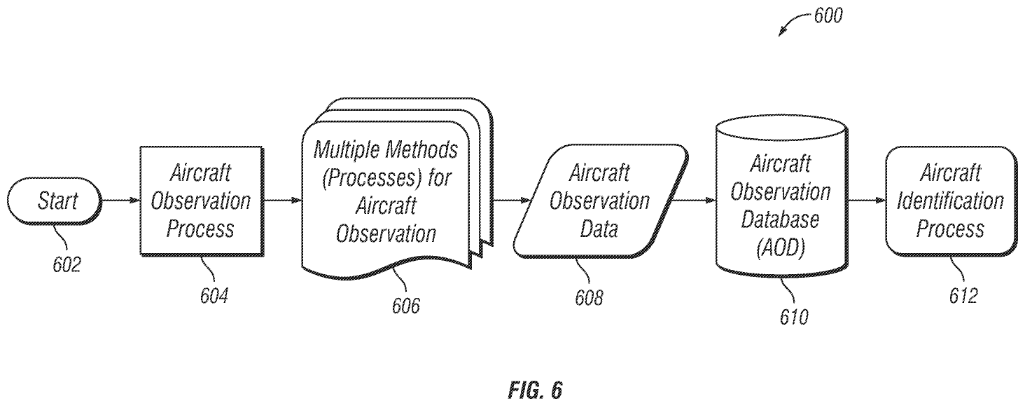

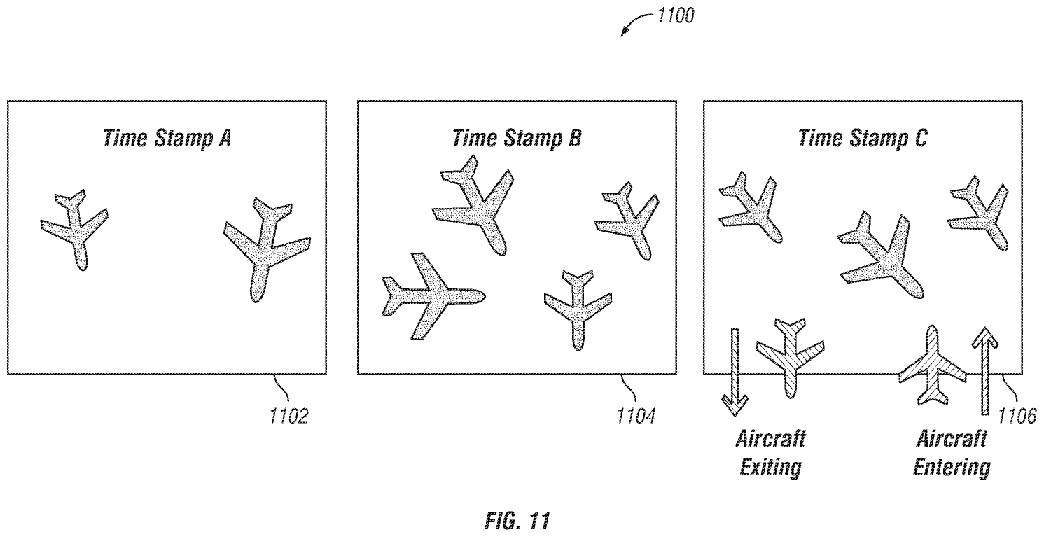

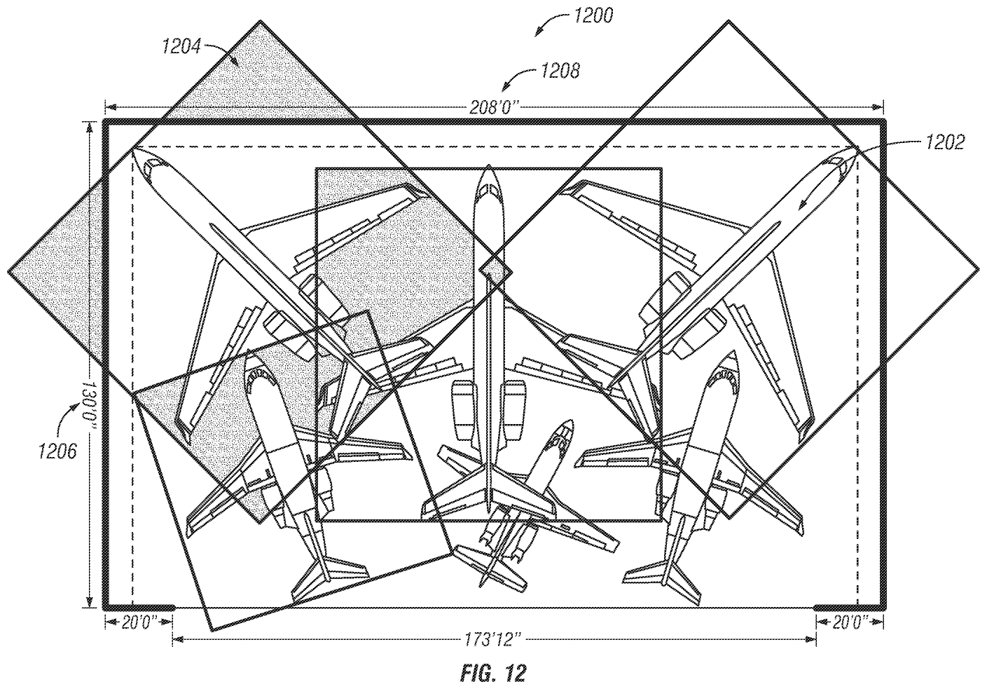

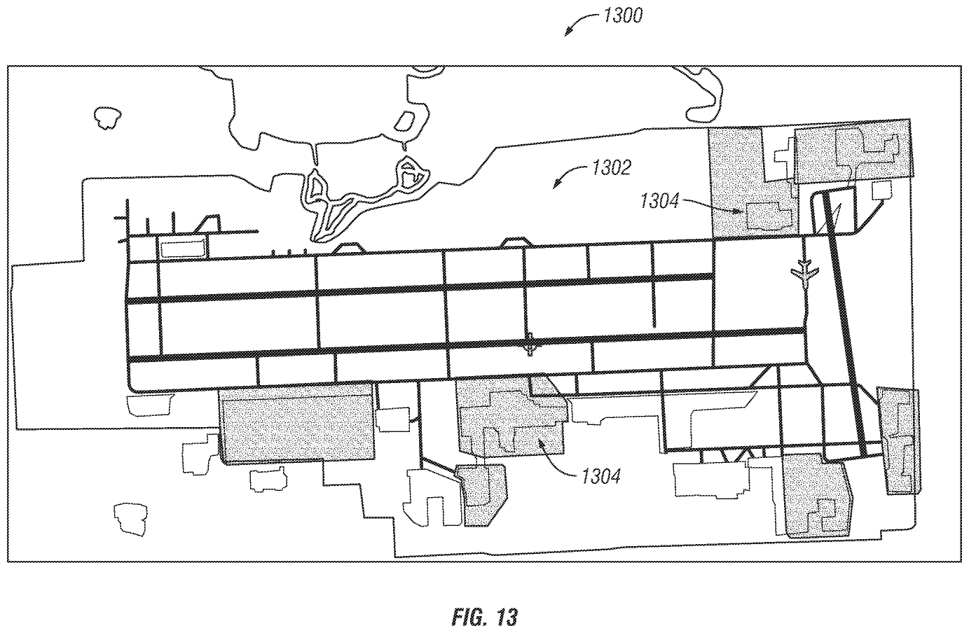

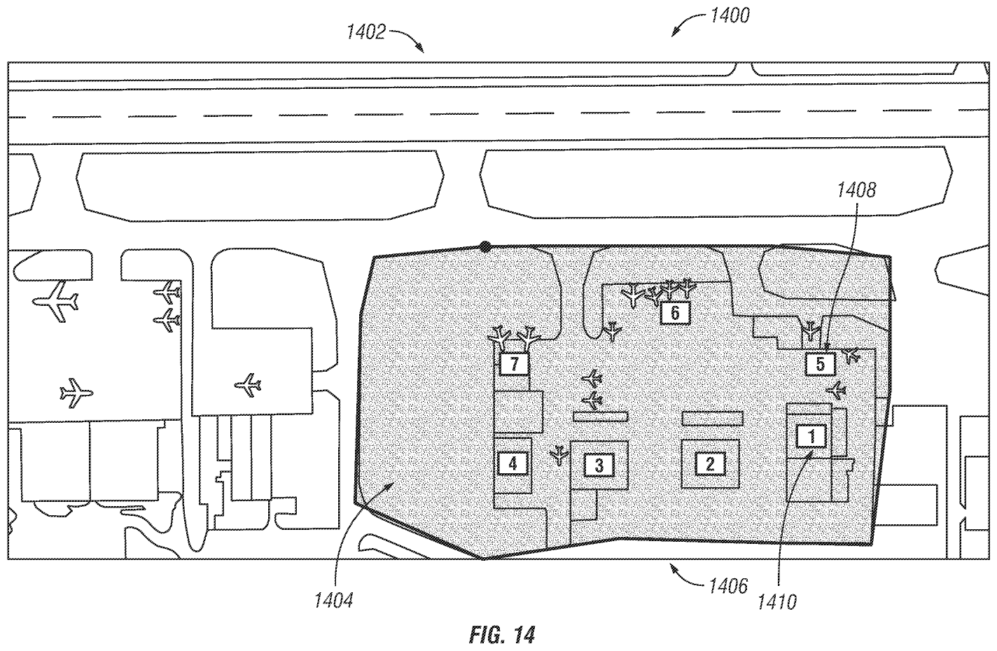

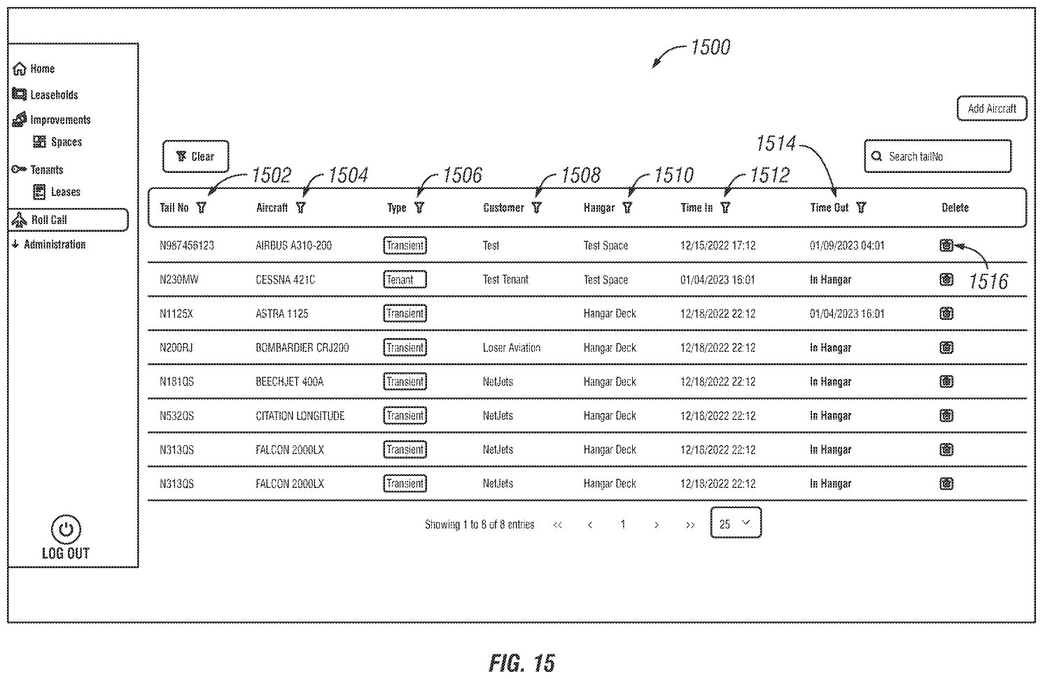

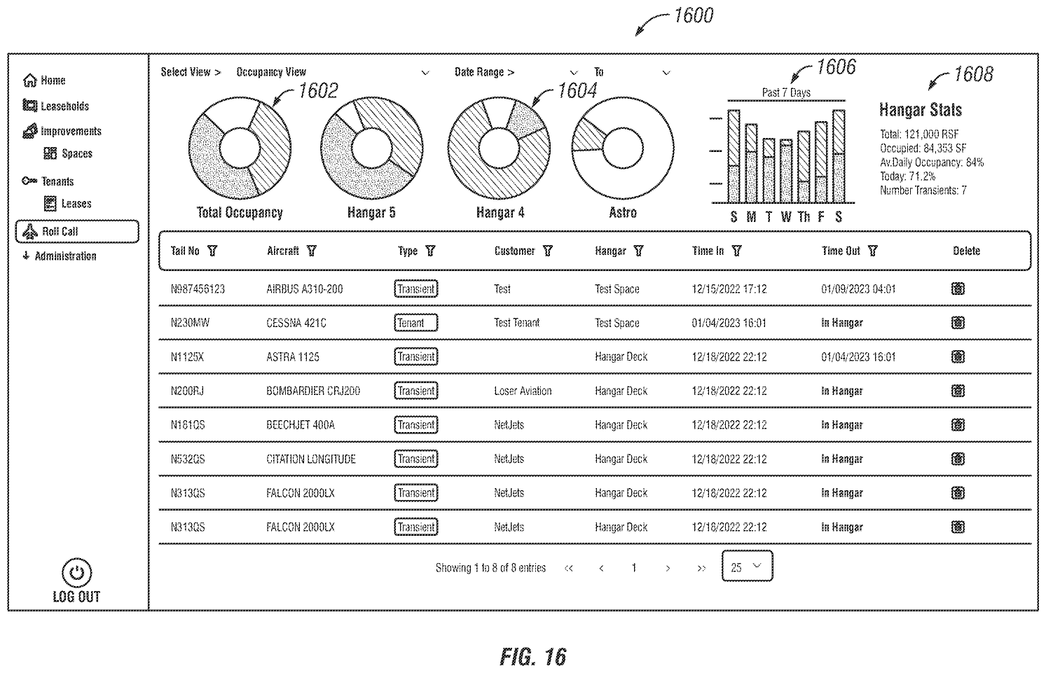

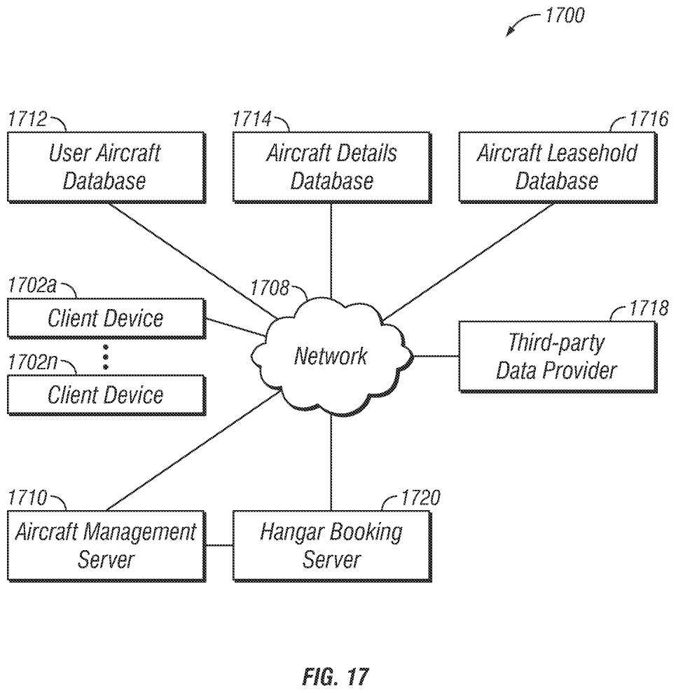

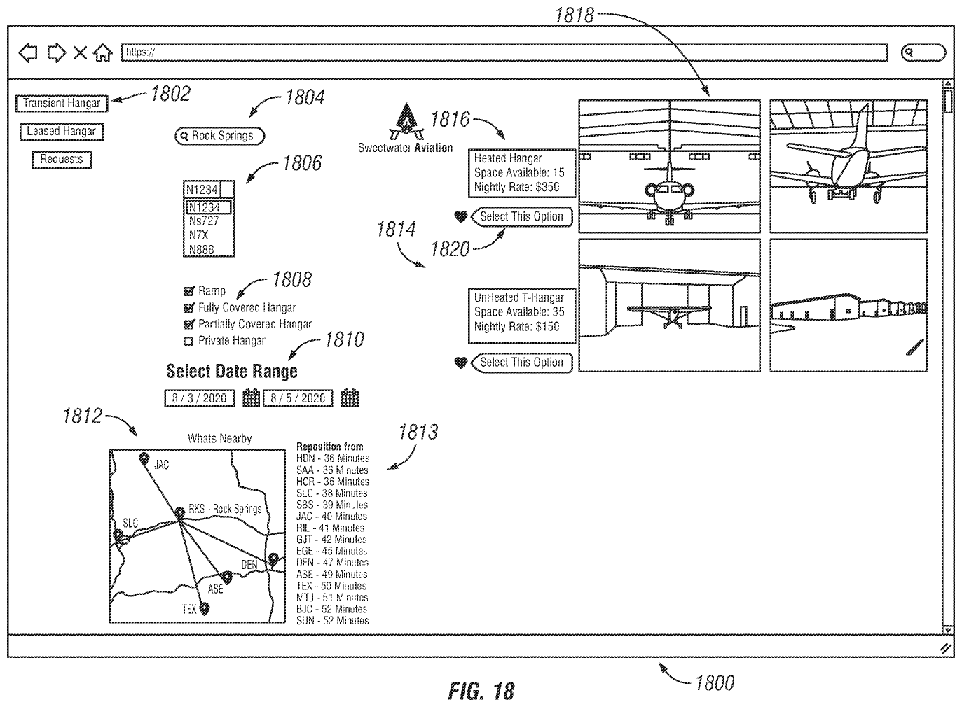

In the disclosure that follows, FIGS. 1-2 are directed to a system for managing aircraft storage. FIG. 3 is directed to a method for managing aircraft storage. FIGS. 4A-4C are directed to methods for observing aircraft. FIGS. 5A-5B are directed to apparatuses configured to manage aircraft storage. FIGS. 6-10 are flowcharts illustrating sub-methods for managing aircraft storage. FIGS. 11-12 are directed to illustrations demonstrating the arrangement of aircraft in a hangar space. FIGS. 13-14 are directed to illustrations showing leaseholds in an airport. FIGS. 15-16 are directed to example embodiments of user interfaces displaying insights and analytics of aircraft storage. FIG. 17 is directed to a system for reserving a hangar space and FIG. 18 is directed to an example embodiment of a user interface for reserving a hangar space. All such figures disclose illustrative embodiments and are not intended to limit the invention as claimed in the claims.

FIG. 1 is a block diagram of a system 100 for managing aircraft storage based on real-time occupancy data according to an illustrative embodiment. Generally, the system 100 includes at least one electronic device 102 accessing an aircraft management server (AMS) 110 via a network 108 to allow one or more users (e.g., FBOs (not shown)) to receive insights and analytics about one or more aircraft storage areas.

The user can be a FBO, an FBO employee, an aircraft operator, ramp personnel, a corporate superuser, or some other user. In some embodiments, the user is granted additional or restricted access to view insights and analytics about one or more aircraft storage areas based on the type of account created for the user in the system 100. In at least one embodiment, a corporate superuser is able to view insights and analytics for all aircraft storage areas owned by FBOs owned or controlled by the corporation. In another embodiment, a FBO employee has access to only a single storage area, such as a single hangar. In yet other embodiments, an aircraft operator does not have access to insights and analytics about the aircraft storage areas, but only has access to aircraft information for the operator's own aircraft.

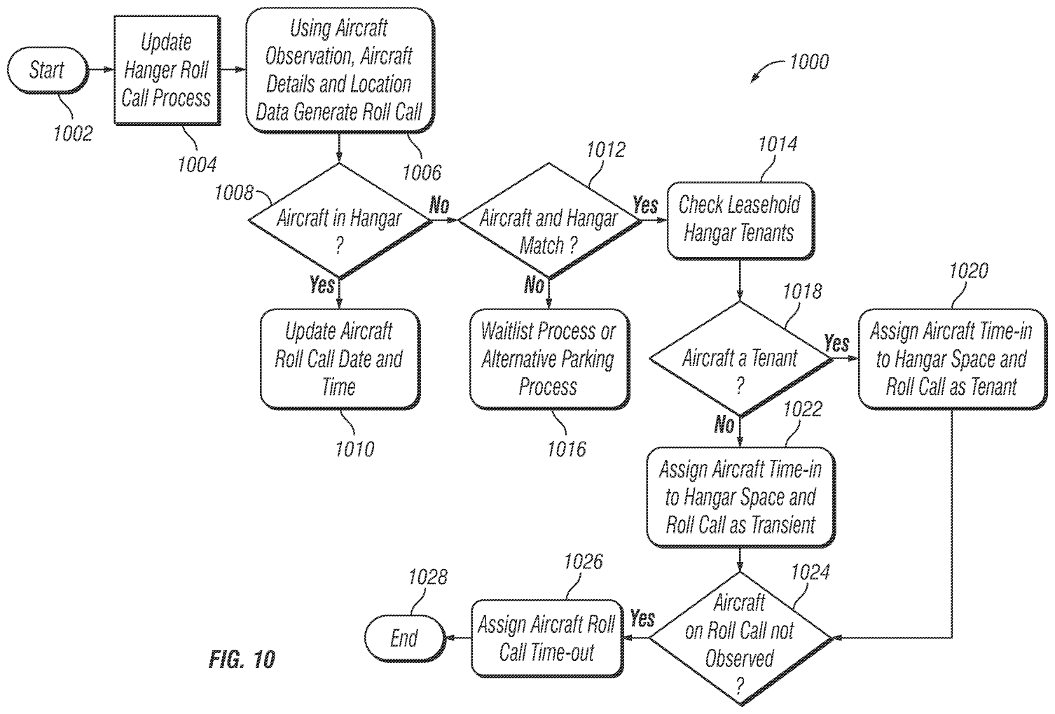

The AMS 110, connected to the network 108, is configured to generate one or more automatically generated parked aircraft entries based on data received from one or more local data sources 104 and one or more external data sources 106 via the network 108. As used herein, “automatically generated parked aircraft entries” may also be referred to in the alternative as “automated entries” for convenience. All of the combined automated and manual entries at any given point in time may reflect an accurate listing of the parked aircraft currently stored in a particular storage area or group of storage areas. In some embodiments, the automated entries may be in the form of a Roll Call, as calculated in FIG. 10. The automated entries can be generated without requiring the operator to manually observe which aircraft are parked in a space, simplifying the storage management process and decreasing the expenses associated with manual observation.

Examples of client device 102 can include cell phones, tablets, desktop computers, or any other form of communications device capable of connecting with and communicating over network 108. The client device can permit communication via conventional means, such as the exchange of emails, text messages, phone calls, and/or videoconference calls. An example of a client device is shown as computing device 550 in FIG. 5B that follows.

The network 108 can include the internet, the Public Switched Telephone Network (PSTN), cellular networks, and local area networks, among others. Communication over the network 108 can be achieved using various forms of communications equipment and protocols. While client device 102 is depicted as communicating through communications links via network 108, in other embodiments, client device 102 can communicate via device-to-device communications protocols.

The AMS 110 is a computing device that can include hardware and software configured to generate automated time entries. An example of the AMS 110 is shown as computing device 500 in FIG. 5A that follows, and an embodiment of a user interface showing a list of automated entries is shown in FIG. 15.

One or more local data sources 104 provide various data to the AMS 110 for generating automated entries. The local data sources 104 can include any number of data sources or methods that are operated or performed by the FBO to gather data about a user's aircraft or databases storing aircraft data. The following discussions show several example data sources and methods.

The predominant method today of identifying and documenting all unique aircraft parked in any given hangar is through manual observation. An FBO employee visually observes a parked aircraft and manually logs the aircraft's registration, its type, the date-time stamp, and the hangar in which the aircraft is parked, in writing. The data is typically captured in an analog list (written log) that must be then transcribed to a digital format for accounting, or other purposes. By itself, manual observation is inadequate to support a real-time, or near real-time view of hangar occupancy.

An Automatic Dependent Surveillance-Broadcast (ADS-B) transponder is a digital radio transmitter placed aboard an aircraft that provides information about the aircraft's registration number and location in the signal. A radio receiver must be within range of the transponder to receive the signal. The location information provided by the ADS-B transponder is not accurate enough to precisely determine the aircraft's position at an airport. Additionally, the transponder is often only turned on while an aircraft has engine power. Aircraft that are being positioned for parking generally will not have this appliance turned on.

Computer vision is a method of optically identifying an object based on a pre-configured code (e.g., Quick Response (QR) codes, barcodes, etc.). If a pre-configured code label is added to an aircraft, a computer vision device can automatically scan the code to identify the aircraft. However, if multiple aircraft are parked in a single space (e.g., a hangar), then the codes may become occluded by other aircraft. Multiple computer vision devices can be positioned in a hangar to decrease occlusion issues. An FBO can use a mobile reader device instead of a fixed device to scan the code, but this requires human labor to handle the mobile reader. Computer vision devices do not provide position data by themselves. However, a code configured to represent a hangar and affixed to it can effectively provide geocode coordinates because the geocode coordinates of the hangar are known and static.

OCR is a method of identifying alphanumeric characters via an optical input device and configured software. OCR can be used to identify the registration numbers printed on the tails of aircraft without needing to add a code to the aircraft beforehand. However, an OCR device can have similar occlusion issues as a computer vision device. Thus, multiple OCR devices may be necessary to decrease the risk of occlusion. OCR devices do not provide position data by themselves.

Other data sources and methods, such as radio frequency identification (RFID), Bluetooth, cellular connections, ultra-wideband signals, WiFi, Global Navigation Satellite System (GNSS), low-power wide-area network (LPWAN), or augmented reality, can alternatively be used by the FBO to gather data about the user's aircraft. These options may have similar advantages and drawbacks as those discussed above. In particular, sources and methods requiring a device to be placed aboard the user's aircraft are not desired because of the additional burden placed on the aircraft operator.

The FBO can record data about an aircraft operator's aircraft in one or more databases, which can be accessed by the AMS 110. The data can include an aircraft's registration number (interchangeably described as a “tail number” in this disclosure), manufacturer serial number, type certificate, dimensions (square footage (SF)), make, model, or other identifiers.

One or more external data sources 106 also provide various data to the AMS 110 for generating automated entries. The external data sources 106 can similarly include any number of data sources or methods, such as those discussed above, that gather data about an aircraft operator's aircraft or databases storing aircraft data. The data from these sources can be gathered by a third party and received by the FBO.

The predominant external data sources 106 available to FBOs are ADS-B data service providers. The collection of ADS-B transponder data can be implemented from a variety of data service providers instead of only one data service provider. Some examples of publicly-available data service providers include FlightAware, Flight Radar 24, and others, which offer greater data fidelity through subscription programs. Specialized third-party data providers not marketed to the general public include PASSUR, AMSTAT, and others. In each case, any one company is a data service provider of ADS-B data. A data service provider must simply provide a tracking software to complement their hardware which receives aircraft transponder signal information.

One or more third-party databases can provide aircraft data to the AMS 110, each being an external data source 106. The data can include an aircraft's registration number (interchangeably described as a “tail number” in this disclosures), manufacturer serial number, type certificate, dimensions (SF), make, model, or other identifiers.

After receiving aircraft data, the AMS 110 can generate automated entries regarding an aircraft operator's aircraft. The automated entries can include the aircraft's registration number, the aircraft type, the type of customer in the hangar, either a Transient or Based Tenant, the customer's name, the aircraft's physical location within a hangar, the date and time at which the aircraft is positioned in the hangar, the status of the aircraft, whether it is still located in the hangar, and the date and time the aircraft departed the hangar. The user can view the automated entries, in addition to analytics and insights calculated from the automated entries (such as hangar occupancy), on the client device 102 by accessing a user interface from the AMS 110.

FIG. 2 is another block diagram of a system for managing aircraft storage based on real-time occupancy data according to an illustrative embodiment. Generally, the system 200 includes at least one electronic device 202a-202n (collectively 202, where n represents any number of electronic devices) accessing a business dashboard system (BDS) located on the AMS 210 via a network 208 to allow one or more users, (e.g., FBOs (not shown)), to receive insights and analytics about the stored aircraft associated with a particular storage area or group of storage areas. The AMS 210, connected to the network 208, is configured to generate one or more automatically generated parked aircraft entries based on data received from one or more of an aircraft observation database (AOD) 212, an aircraft details database (ADD) 214, an aircraft leasehold database (ALD) 216, a third-party data provider 218, a sensor assembly 220, and at least one FBO mobile device 222a-222n (collectively 222, where n represents any number of mobile devices) via the network 208.

Client device 202, network 208, and AMS 210 can correspond to client device 102, network 108, and AMS 110 respectively as shown in FIG. 1.

The aircraft observation database 212 can be a database that stores data gathered from at least one sensor assembly 220 and the FBO mobile device 222. In some embodiments, the AOD 212 is a structured set of data stored in a discrete computing device 500 as shown in FIG. 5A. In other embodiments, the AOD 212 is in the same computing device with one or more of the AMS 210, ADD 214, or ALD 216. The at least one sensor assembly 220 can comprise one or more devices configured to observe an aircraft using the observation methods discussed above. The FBO operator mobile device 222 can be a computing device 550 as shown in FIG. 5 configured to observe and identify an aircraft or alternatively to scan a code label on the aircraft or hangar. In at least one embodiment, the FBO operator mobile device 222 is configured to perform OCR and computer vision. Further, the FBO operator mobile device 222 can be configured to generate a time-date stamp and geocode coordinates using the mobile device 222 GPS coordinates recorded while observing an aircraft.

The at least one sensor assembly 220 can be configured to automatically observe aircraft in a hangar space. To provide real-time occupancy and available parking locations, aircraft that are parked in any space within an improvement on a leasehold can be observed in this process, via a feature referred to as “Roll Call,” shown in FIG. 10.

The AMS 210 can be configured to use an algorithm for interpolating each aircraft's location within a given hangar using a multitude of observation methods to improve quality of data capture. Multiple input methods can be used to ensure data quality. For example, an ADS-B transponder on an aircraft can send geocode coordinates to indicate an aircraft's rough geographic position (such as at a particular airport). If another observation method that can generate geocode coordinates, such as a mobile device, observes the aircraft then the two sets of coordinate data can be compared, with the more recent or precise method updating the data. It is this combination which allows for the AOD to provide automated updates, and real-time occupancy data. In at least one embodiment, users are presented with a visual confirmation that the aircraft's registration information is correct. Additionally, users can be presented with a time, date, and geocode stamp confirming that the aircraft is located at a specific hangar that will have been validated by a mobile device, such as the FBO mobile device 222. An aircraft can be validated by OCR, QR codes, or other means and by the user which accepts an entry as correct.

The ADD 214 can be a database that stores aircraft details, such as an aircraft's manufacturer serial number, type certificate, dimensions, make, model, or other identifiers. In some embodiments, the ADD 214 is a structured set of data stored in a discrete computing device 500 as shown in FIG. 5A. In other embodiments, the ADD 214 is in the same computing device with one or more of the AMS 210, AOD 212, or ALD 216. The ADD 214 can be configured to group aircraft into categories based on each aircraft's dimensions. In at least one embodiment, the ADD 214 can assign the aircraft a Real Estate Categorization (RECAT) value (e.g., “Large”) based on the aircraft dimensions. The AMS 210 can be configured to compare data stored in the AOD 212 with the ADD 214 to ensure that the observed data is consistent with the aircraft details. If the data for any aircraft is inconsistent, the ADD 214 can be updated.

A principal goal of the disclosure is to ensure that data collection entered into the AOD 212 is free of errors. Issues of data quality are exacerbated when collating aircraft specifications manually because of the large number of manufacturers and type of aircraft. Presently, there is no single reliable database that provides all the information necessary to identify any given aircraft (much less has access to information which is manufacturer validated).

A major pitfall to data entry in the business and general aviation industry is that aircraft generally have multiple names (common names, specific model names, and combinations of both with slight changes based on aircraft modifications). A very involved/confusing naming convention ensues across thousands of aircraft, which typically baffle all but the most educated of professionals. Not only does having error-based information in a database create incorrect reporting, it also can relate to real-world safety issues. If a database is created with incorrect aircraft measurements, planning for positioning aircraft inside of a hangar can be prone to incorrect analysis of hangar space available.

To help alleviate this problem, the ADD 214 can comprise data from multiple databases available from one or more third-party data providers 218. The databases can include multiple aircraft registration databases to ensure that a high level of data quality is being entered. A few examples of these databases include AMSTAT, Jetnet, and the Federal Aviation Administration (FAA) Aircraft Registration Database.

A unique characteristic of the ADD 214 is that by positively identifying the exact aircraft by Serial Number, as opposed to simply the common make and model of the aircraft, specific modifications that may alter the aircraft's three dimensions are captured. For example, an aircraft's make and model, such as a Dassault Falcon 900, may yield the manufacturer's as-built dimensions in terms of wingspan (W), length (L), and tail height (T); identifying the exact Serial Number allows the ADD 214 to identify that the aircraft is equipped with after-market modifications that affect one or more of the dimensions of the aircraft, and consequently the space needed to store the aircraft.

Returning to the example aircraft, a Dassault Falcon 900, manufactured between 1984 and 1991, has a “stock” wingspan (W) of 63′ 5″, a length (L) of 66′ 4″ and a height (T) of 24′ 9″. The ADD 214 can automatically compute any dimension (W, L, or T) that exceeds a whole number, by rounding up to a whole number. Hence, the W as described above would round from 63′ 5″ to 64′. Similarly, L and T are also rounded up to 67′ and 25,′ respectively. This results in an aircraft square footage (SF) of 4,288 ft².

While an aircraft's SF is critical to ensure there is sufficient Rentable Square Footage (RSF) of a hangar floor space proposed to be used for storage of the aircraft, the T categorizes the aircraft in the ADD 214 as a “Large” aircraft for RECAT purposes in one embodiment. RECAT is used to match the appropriate hangar to a given aircraft to ensure the height of the hangar door will allow the aircraft to pass through. A small RECAT aircraft can be characterized as a T between 0′ 0″ and 17′ 11″. A medium RECAT aircraft can be characterized as a T between 18′ 0″ and 24′ 11″. A large RECAT aircraft can be characterized as a T between 25′ 0″ and 27′ 11″. An ultra-large RECAT aircraft can be characterized as a T between 28′ 0″ and 65′ 0″. Helicopters are similarly categorized by rotor diameter (R) multiplied by L, defined as the main rotor blade furthest forward, to the tip of the tail rotor or “stinger,” the protrusion from a tail boom of a helicopter to establish its L.

By way of further illustration, certain Falcon 900 aircraft have been modified by their operators with the addition of “winglets,” curved, upward protruding wingtip extensions designed to reduce transonic drag, and thus decrease fuel burn. The winglets, produced by Aviation Partners, Inc. (API), and installed by authorized maintenance centers, increase W to 70′ 2″.

Hence, using the rounding methodology of the ADD 214, a Falcon 900 modified with API winglets, has a W of 71′, and when multiplied by the same L (67′), the new square footage is 4,757 SF for a modified version of the Falcon 900. The net difference (469) feet, is a significant difference from the original Falcon 900, as constructed.

The positive identification of the exact aircraft using serial number—not just its make and model—when coupled with the RECAT for the aircraft, fully categorizes the aircraft and allows for more accurate storage planning. When matched with the ALD 216, and the unique dimensions and door size limitations of each hangar, the system 200 can automatically determine if a specific aircraft can fit in a hangar, or not.

The ALD 216 can be a database that stores data defining an aircraft's location on an airport, and more specifically, within or about an improvement, and that improvement's location on a specific parcel of land within an airport. In some embodiments, the ALD 216 is a structured set of data stored in a discrete computing device 500 as shown in FIG. 5A. In other embodiments, the ALD 216 is in the same computing device with one or more of the AMS 210, AOD 212, or ADD 214. As used in this disclosure, an “improvement” is any structure, such as a paved aircraft parking apron, or a building, such as a hangar, that can accommodate a parked aircraft.

Improvements at airports are located on apportioned parcels of land, referred to as “leaseholds,” which are defined areas of an airport under the care, custody, and control of a third-party (as opposed to the airport itself). As most public use airports in the United States are owned and operated by governmental organizations such as a city, municipality, authority or state, airport land is leased (not sold) to third parties for various aviation uses. FBOs for example, will typically have improvements in the form of paved aircraft parking aprons, and hangars for aircraft storage on their leaseholds. However, in some cases the owner of the airport may directly operate the improvements, and the term leasehold is used generally herein to refer to any defined space used for storage of aircraft.

Within each improvement are “spaces,” which are the physical locations within an improvement capable of storing a parked aircraft. Hence, within an airport are various leaseholds; within each leasehold are improvements, and within each improvement are spaces, and aircraft are parked with those spaces. The number of aircraft able to be parked within any space is dependent upon the amount of square feet of each space, combined with the various aircraft sizes parked within. The ALD 216 can store information regarding the spaces within each improvement, including the internal dimensions of the hangar floor itself in available usable or rentable (RSF), defined as the length and width of a given hangar floor, with a user-override process to account for internal structures that affect RSF.

Further, the specification for a hangar's door in both width (DW) and height (DH) is captured for each hangar improvement, allowing the system to automatically determine and match which RECATs can (or cannot) fit three-dimensionally into a given hangar, even if sufficient floor space appears available based on an aircraft's square footage alone. Like the ADD 214, which can store an aircraft's external dimensions not just by make and model, but by exact aircraft serial number, and can categorize the aircraft by RECAT, the ALD can use a similar formula to match the appropriately sized hangar to accommodate a specific aircraft.

Hangar information stored within the ALD 216, like aircraft information stored within the ADD 214, can be grouped into categories based on the physical dimensions of the hangars. While the RSF of a hangar must exceed the SF of a given aircraft to house it as defined in the ADD 214, SF within the ADD 214 is a two-dimensional model which considers only L×W of an aircraft. RECAT, which accounts for the T of an aircraft, is paired with the hangar door dimensions to ensure an aircraft will fit in a given hangar, assuming available RSF. Thus, a particular hangar is only available for storing a particular aircraft if the SF available in the hangar is greater than the SF of the aircraft, and the RECAT of the hangar is equal to or greater than the RECAT of the aircraft.

Hangar categories thusly, are not defined by RSF, but rather the door height of a given hangar firstly, and RSF secondarily. This contextualizes an “Improvement Match,” between the ALD 216 and ADD 214.

The ALD 216 can be configured to store data detailing features of each improvement, including the internal dimensions of a hangar itself in length and width, with the ability to account for internal structures that affect usable space. Further, the door size specification both in width and height is captured for each hangar improvement, allowing the system 200 to determine which aircraft types can (or cannot) fit three-dimensionally into a given hangar, even if sufficient floor space appears available based on an aircraft's square footage alone.

Door height (DH) is first considered in improvement matching within the ALD, because a relation exists between door height of a hangar and its RSF, whereas the reverse is not true. The ALD 216 can define hangars by size categories. A “small” aircraft hangar can have a DH between 18′ 0″ and 24′ 11″. A “medium” aircraft hangar can have a DH between 25′ 0″ and 27′ 11″. A “large” aircraft hangar can have a DH of 28′ 0″, or greater.

Large hangars are generally newer, purpose-built structures to accommodate aircraft within the large RECAT category that have specific wingspans (including those with aftermarket modifications) and tail heights. For example, the large hangar is minimally designed to accommodate both the T and the W of large aircraft, permitting the aircraft's entrance into the hangar. Due to this design criteria, the RSF is sufficient as well.

The reverse is not true however, as a hangar with a significant RSF may be of an older type designed with a DH that predates the advent of large aircraft, or FAA restrictions under 14 CFR Part 77 may dictate (and restrict) a given hangar improvement's total height (and thus, DH) based on its proximity to a runway, for example.

Hence, a large hangar of 20,000 RSF within the ALD means it will have a hangar door tall and wide enough to accommodate ANY large or smaller aircraft within the ADD 214, whereas a small hangar may have 40,000 RSF, but its door height can only accommodate small aircraft within the ADD 214 (those with a tail height of 17′ 11″ and below). As a result, the RSF of a large hangar is the most flexible, able to accommodate any aircraft large and below, assuming sufficient RSF exists.

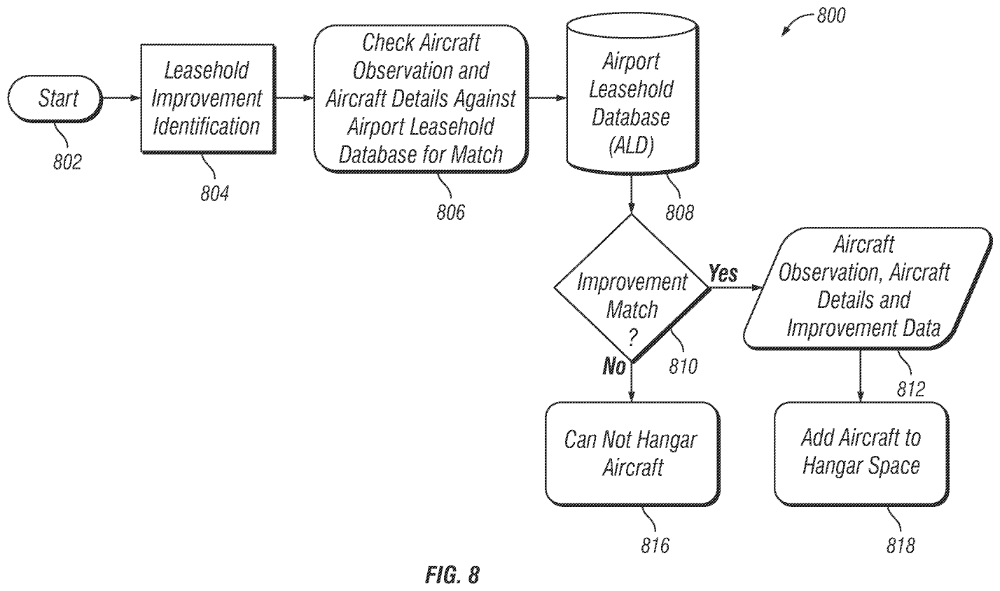

The ALD 216 can also be configured to store leasehold information captured as part of the process shown in FIG. 8. This leasehold information can include the surveyed metes and bounds (physical boundaries) of a given parcel of land, or leasehold. These boundaries can be stored as geofences, which create specific areas under the control of a single entity, such as an FBO. Examples of geofencing that define airport leaseholds 1304 are illustrated in FIGS. 13 and 14, below.

Combining data from one or more of the AOD 212, the ADD 214, the ALD 216, and one or more third-party data providers 218, the AMS 210 can be configured to present data regarding aircraft parked in a space to the client device 202 via the network 208. The parked aircraft data can be the insights and analytics in the form shown in FIGS. 15 and 16.

FIG. 3 is a drawing depicting a flowchart 300 of a process for aircraft storage management. The process involves observing and identifying an aircraft, identifying leaseholds capable of accommodating the aircraft, adding the aircraft to a space, updating Roll Call, and providing insights and analytics based on the aggregate data.

In step 302, an aircraft is observed using one or more observation methods. The process can be the process shown in flowchart 600 of FIG. 6. In at least one embodiment, data gathered from the one or more observation methods is stored in an AOD. In some embodiments, data from an observation method overwrites conflicting data from another observation method. In at least one embodiment, the overwriting observation method is manual observation.

The process is agnostic to the observation method vendor, equipment or software used to make the aircraft observation. Many off-the-shelf solutions, such as those discussed with reference in FIG. 1, can be applied to observe aircraft. In at least one preferred embodiment, more than one observation method is used to observe aircraft. Using more than one method increases the likelihood that all aircraft are properly observed, and sufficient data is gathered to perform one or more methods of this disclosure.

In a preferred embodiment, the data for an observed aircraft comprises at least an aircraft registration, the time and date of observation, and geocode coordinates. If the observation method does not include geocode coordinates, geocode coordinates can be captured with a separate observation method. Of the observation methods discussed in FIG. 1, (ADS-B, manual observation, computer vision, and OCR) ADS-B is the only observation method that currently captures geocode coordinates in the raw data. All other observation methods require an additional data-gathering source capable of generating a precise geocode that can be associated with the observation data.

In at least one embodiment, geocode coordinates are gathered from a user's computing device, such as computing device 550 in FIG. 5B, to provide geocode coordinates for an aircraft.

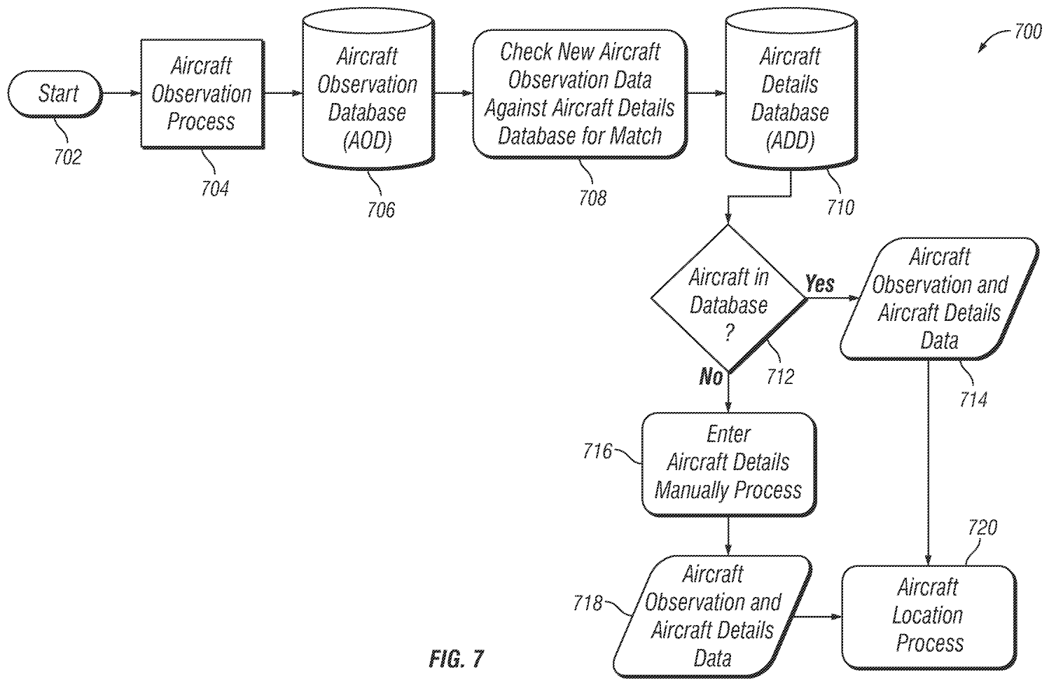

In step 304, an aircraft is automatically identified using the data gathered from step 302. The aircraft identification process can be the process shown in flowchart 700 of FIG. 7. In at least one embodiment, aircraft observation data stored in an AOD 212 is compared with aircraft specification data stored in an ADD 214, as shown in FIG. 2.

The aircraft storage management process aims to solve aircraft identification and data-entry issues by integrating an ADD with subscription-based, aircraft specification data providers (whose sole focus is data quality), such as AMSTAT, Jetnet, and AircraftBluebook. Consumers of this process are first required to enter in an aircraft's identifying information (registration or serial number). The ADD takes this information, cross-checks it against the subscription database to verify information was correctly entered and matches the plane to an existing FAA-registered aircraft. The ADD then enforces record creation by comparing the AOD data with the correct aircraft make, model, serial number, and sizing dimensions.

In step 306, an available leasehold improvement is automatically identified based on the identified aircraft in step 304. The leasehold identification process can be the process shown in flowchart 800 of FIG. 8. In at least one embodiment, a FBO manually enters specifications about a leasehold improvement, such as the DH, DW, RSF, address, building dimensions, or other improvement data in a user interface for an aircraft management system. The improvement data are then stored in an ALD.

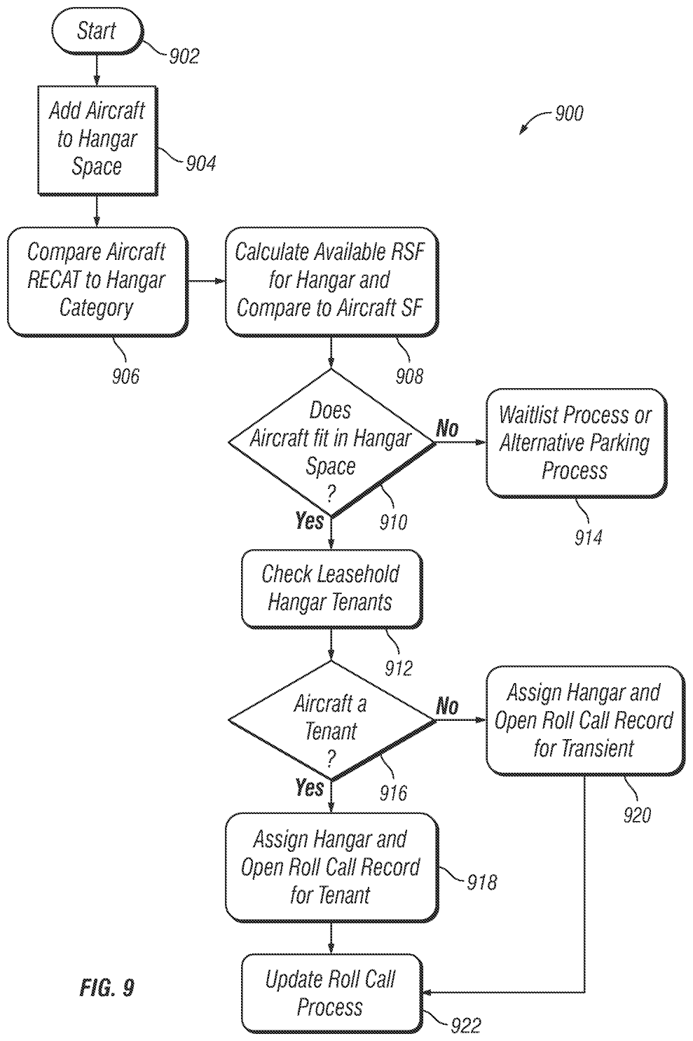

In step 308, an aircraft is added to a hangar space based on the identified leasehold improvements in step 306. The process of adding an aircraft to a hangar space can be the process shown in flowchart 900 of FIG. 9. The term “hangar space” as used within this disclosure is not limited to an enclosed building, but includes any spaces in an improvement capable of holding a parked aircraft, such as a paved aircraft parking apron 1408 shown in FIG. 14.

In step 310, the information regarding each aircraft stored is updated, what is referred to herein as updating the Roll Call. The Roll Call is updated anytime an aircraft is added or removed from a hangar space. The Roll Call interface allows an FBO to track the aircraft that are currently in each hangar as well as times of departure for aircraft removed from the hangar. Updating Roll Call can be the process shown in flowchart 1000 of FIG. 10.

In step 312, insights and analytics pertaining to the aircraft stored in a hangar can be provided to a FBO. The insights and analytics can be provided using a BDS 1600 shown in FIG. 16.

FIGS. 4A-4C illustrate various observation methods for observing an aircraft 400. Each method may be used for aircraft observation as shown in FIG. 6.

FIG. 4A shows a technique for observing an aircraft 400 by using an equipped ADS-B transponder 410 that communicates to a receiver 412 operated by an FBO to determine the aircraft's 400 position. The usage of ADS-B transponder data provides data regarding an aircraft's operation to and from airports. ADS-B data can be used to trigger or notify an FBO that an aircraft has arrived at or departed from a specific airport or group of airports, which can prompt another observation method to verify if the aircraft is in its assigned parking spot. As aircraft transponders only emit ADS-B signals when an aircraft is electrically powered the transponder is in the “Standby” or “Altitude-Encoding” mode, transponders only provide aircraft location information when the transponder is powered up by the aircraft systems.

FIG. 4B shows a technique for observing an aircraft 400 equipped with a pre-configured code label 420 providing identifying information about the aircraft 400. As discussed above, computer vision can include barcodes, QR Codes, and the like. This method of observation uses a machine-readable optical label that can contain information about the item to which it is attached. In this case the optical label 420 can allow access to pertinent information about the aircraft 400, such as its registration number, aircraft type, modifications, and servicing requirements.

A curated optical label 420 may be produced and affixed to a reasonably accessible location on the aircraft 400 where an FBO employee can use a hand-held mobile reader to scan the label and capture the data. The placement of a QR code (or similar) on an aircraft requires approval from either an aircraft's owner or operator. In at least one preferred embodiment, the optical label is a QR Code. In some embodiments, the observation method requires that all Based Tenants maintain a QR Code affixed to the aircraft 400 and all transient aircraft have a QR Code 420 affixed upon arrival and parking in the hangar.

Although the aircraft QR code 420 may include all the pertinent data needed about the aircraft 400 (E.g., aircraft registration, etc.), at the time of scanning, the hand-held mobile reader can also capture the time-date stamp and geocode coordinates. In addition, a QR Code 422 can be affixed to the hangar door and associated with pertinent information about the hangar. The hangar QR Code 422 can include detailed geocode coordinates for the hangar to allow confirmation of the hangar where the aircraft has been stored.

FIG. 4C shows a technique for observing an aircraft 400 using a hangar space equipped with an OCR device 430 identifying an aircraft 400 based on the aircraft's tail number 432.

OCR has been shown to be an accurate medium for correctly capturing the aircraft registration (i.e., tail number 432) expressed as an alpha-numeric set of characters. OCR is a practical and accurate optical reader technology that can help autonomously identify aircraft at an airport. Often, OCR is used by large airports to positively identify aircraft for FAA operational data purposes—tracking takeoffs and landings at a given airport. In such instances, OCR works particularly well in airside environments when aircraft are required to follow the same taxiways ensuring a high degree of confidence that every aircraft will be observed via OCR.

The application of OCR in a hangar environment is problematic given the array of different ways aircraft 400 can be positioned or organized within a given hangar (such as the layout of the hangar in FIG. 11) and the various sizes and heights of aircraft causing the tail number 432 to be obscured from any number of different OCR optical reader angles. A method to overcome this obstacle is to place OCR cameras 430 in such a way to capture aircraft registration numbers when the aircraft 400 is either being towed into or out of the hangar. Similar to a QR Code, the OCR observation method can capture the aircraft registration number, but the OCR reader can be configured to add a time-date stamp and geocode coordinates. Once the registration number has been captured, then additional information regarding the aircraft can be captured from various third-party databases if the FBO has not already stored the aircraft information.

FIGS. 5A and 5B show examples of apparatuses with at least one processor capable of executing instructions to perform the steps of flowcharts 300, and 600-1000 in FIGS. 3 and 6-10 respectively. The apparatuses can also be implemented according to the systems in FIGS. 1-2 and 17. The apparatuses may be a generic computer device 500 as shown in FIG. 5A and a generic mobile computer device 550 as shown in FIG. 5B, which may be used with the techniques described here. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low-speed interface 512 connecting to low-speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high-speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, memory on processor 502, or a propagated signal.

The high-speed controller 508 manages bandwidth-intensive operations for the computing device 500, while the low-speed controller 512 manages lower bandwidth-intensive operations. Such allocation of functions is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD (Thin-Film-Transistor Liquid Crystal Display) or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, memory on processor 552, or a propagated signal that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a BLUETOOTH, WIFI, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

FIG. 6 is a flowchart 600 of a process for observing aircraft in accordance with an illustrative embodiment. The steps of flowchart 600 can be performed automatically with a computing device 500 shown in FIG. 5A. In at least one embodiment, the process 604 is initiated 602 automatically by the computing device 500. For example, the computing device 500 can receive a signal from a sensor that observes when an aircraft enters or exits a hangar, using an observation method discussed above, to initiate 602 the process 604. In another example, the computing device 500 can receive geocode coordinates from an ADS-B transponder device onboard an aircraft. The computing device initiates 602 the process 604 when the geocode coordinates of the ADS-B transponder match the geocode coordinates of a hangar stored in an ALD.

In step 606, an aircraft is observed using one or more methods as described above, such as an OCR sensor capturing a tail number, a reader scanning a QR code on an aircraft or hangar, an ADS-B transponder sending a signal containing location data, or some other method. The methods can be automated to gather and assimilate aircraft observation data 608. In at least one preferred embodiment, the aircraft observation data for an observed aircraft includes an aircraft registration number, the time, the date, and the geocode coordinates of the observed aircraft.

When the aircraft observation data is gathered 608, it is then stored in an AOD 610. The database may be a computing device, such as the device shown in FIG. 5, and implemented in a system, such as system 200 in FIG. 2. After the aircraft observation data is stored in the AOD 610, the aircraft identification process 612, as shown in FIG. 7, can begin automatically.

FIG. 7 is a flowchart 700 of an aircraft identification process in accordance with an illustrative embodiment. The steps of flowchart 700 can be performed automatically with a computing device 500 shown in FIG. 5A. In at least one embodiment, the process 704 is initiated 702 automatically by the computing device 500 upon receiving aircraft observation data.

In step 706, aircraft observation data is retrieved from an AOD. In at least one preferred embodiment, the aircraft observation data includes an aircraft registration number, the time, the date, and the geocode coordinates of the observed aircraft.

After the aircraft observation data is retrieved 706, it is checked against an ADD for a match 708. A copy of the aircraft observation data is sent to the ADD 710 where it is compared against existing aircraft profiles 712. If the aircraft observation data and the aircraft details data match each other 714, then both sets of data are sent to the aircraft location process 720 (also referred to as the leasehold improvement identification process) as shown in FIG. 8. It is possible for the aircraft details data to contain extra specifications not found in the aircraft observation data, or vice versa. In some embodiments, as long as the aircraft observation data and the aircraft details data are not inconsistent with each other, the process continues to the aircraft location process 720.

If the aircraft observation data does not match an aircraft in the ADD, then a user can be prompted to manually enter aircraft details 716 about the observed aircraft. In some embodiments, the user manually enters the aircraft details through a computing device 500 or 550 shown in FIGS. 5A and 5B respectively. After both sets of aircraft observation data and aircraft details data are completed 718, the process continues to the aircraft location process 720 as shown in FIG. 8, which can begin automatically.

FIG. 8 is a drawing depicting a flowchart 800 of a leasehold improvement identification process. The steps of flowchart 800 can be performed automatically with a computing device 500 shown in FIG. 5A. In at least one embodiment, the process 804 is initiated 802 automatically by the computing device 500.

In step 806, aircraft observation data and aircraft details data are checked against an ALD for a match 806. A copy of the aircraft observation data and the aircraft details data are sent to the ALD 808 where it is compared against existing leasehold improvement profiles 810. As discussed in FIG. 2 above, the ALD will consider the physical dimensions of the aircraft and the hangar, including DH and DW, to decide whether a leasehold improvement is capable of storing the aircraft. If the aircraft is already in the hangar, as shown in the observation data or manually entered by a FBO, then the aircraft is considered to match the improvement 812.

If the aircraft observation data and the aircraft details data match a leasehold improvement profile in the ALD 812, then the three sets of data—the aircraft observation data, the aircraft details data, and the leasehold improvement data—are sent to process for adding an aircraft to a hangar space 818, as shown in FIG. 9.

If the aircraft observation data and the aircraft details data do not match a leasehold improvement in the ALD, then the process 804 is unable to find a hangar for the aircraft 816, and the process ends. In some embodiments, a computing device 500 or 550 shown in FIGS. 5A and 5B respectively, returns an error or some other notification that no matching leasehold improvement was found. After the three sets of data are acquired, the process for adding an aircraft to a hangar space 818, as shown in FIG. 9, can begin automatically.

FIG. 9 is a drawing depicting a flowchart 900 of a process for adding an aircraft to a hangar space. The steps of flowchart 900 can be performed automatically with a computing device 500 shown in FIG. 5A. In at least one embodiment, the process 904 is initiated 902 automatically by the computing device 500.

In step 906, a RECAT category of the subject aircraft, found in the aircraft details data from the ADD, is compared to a hangar category in the ALD 906. This step determines if there are one or more hangars of the correct category within the ALD capable of accommodating the subject aircraft in a user's one or more leaseholds. Once a hangar (or hangars) within the ALD are identified to match the aircraft's RECAT category, the available RSF of the matched hangars is calculated to determine if sufficient space exists within the hangar, to accommodate the subject aircraft's SF 908. After this, the calculated available hangar RSF and aircraft SF are compared to see if the aircraft can fit in the hangar space 910.

If sufficient space is unavailable, the system puts the subject aircraft on a waitlist, and the process ceases until sufficient space becomes available 914. If sufficient space is available, then the aircraft is checked to see whether it is a Tenant or Transient aircraft 912. Tenants are identified from a list of Tenant aircraft registration numbers that are added to the system by a user 916. If the aircraft registration number is not recognized, the system identifies the aircraft as a Transient. Assuming sufficient space is available for the aircraft, a hangar is assigned, and a Roll Call record is opened for the Tenant 918 (or Transient 920). After the Roll Call record is opened for either a tenant or transient aircraft, the process for updating Roll Call 922, as shown in FIG. 10, can begin automatically.

FIG. 10 is an illustration of a flowchart 1000 for a process for updating a hangar Roll Call. The steps of flowchart 1000 can be performed automatically with a computing device 500 shown in FIG. 5A. In at least one embodiment, the process 1004 is initiated 1002 automatically by the computing device 500.

Similar to a student raising his or her hand in elementary school to establish their presence at the beginning of the day, Roll Call works similarly using the aforementioned data sets to establish exactly which aircraft are located where within various improvements, to determine both the current occupancy metrics, and the available unused space that may be made available to other aircraft. Unlike elementary school, however, Roll Call, as the system is designed, is continuously updated via manual observation, OCR, computer vision, and other methods, providing a real-time view occupancy.

In step 1006, aircraft observation data, aircraft details data, and location data are used to generate a Roll Call 1006 for a particular hangar. Using aircraft observation data, a given aircraft is checked to see if it is already in the hangar 1008. As aircraft are observed in the hangar, the system creates a time/date record as “In Hangar.” If the aircraft observation data aircraft shows that the aircraft is in the hangar space, then the Roll Call date and time are updated 1010, and the process ends.

During the Roll Call process, the system continuously captures and updates historical data, and allows for multiple insights, such as real-time occupancy, average occupancy, peak periods, frequency of aircraft movements, and duration of stay, among others.

If the aircraft is not currently in the hangar, then the aircraft and the hangar are compared to see if the aircraft can fit inside the hangar 1012. In some embodiments, this process is the leasehold improvement identification process 800 in FIG. 8. If the aircraft cannot fit inside the hangar, then the aircraft is waitlisted or given an alternative parking process 1016. In some embodiments, the alternative parking process 1016 is a suggestion to the aircraft operator for another hangar that has space to hold the aircraft. If the aircraft can fit in the hangar, then the aircraft is checked against the leasehold hangar tenants 1014, to see if the aircraft is a tenant's aircraft 1018.

If the aircraft belongs to a tenant, then the aircraft is assigned a Roll Call “Time-In” for the hangar and Roll Call is updated with the aircraft listed as a tenant 1020. If the aircraft does not belong to a tenant, then the aircraft is assigned a Roll Call “Time-In” for the hangar and Roll Call is updated with the aircraft listed as a transient 1022.

If at any point, the aircraft on Roll Call is not observed 1024 (i.e., no longer present), a Roll Call “Time Out” is out added at the time of observation 1026, and the Roll Call process ends 1028. To determine if the aircraft on Roll Call is not observed 1024, one or more sensors can detect when the aircraft exits the hangar space and provide a time-stamp for the Time Out. In addition, or alternatively, a FBO can manually select that the aircraft is not observed 1024.

In addition to real-time data capture, Roll Call is also performed automatically, at least once a day, at a user-defined time (typically at or near midnight) to establish which aircraft are parked overnight for accounting and billing purposes. This is particularly germane to transient aircraft, which an FBO may charge a nightly rate.

FIG. 11 is an illustration of a hangar 1100 at different time stamps in accordance with an illustrative embodiment. In time stamp A 1102, two aircraft, one small and one large, are parked within the hangar 1100. At time stamp B 1104, four aircraft, two small and two large, are parked within the hangar 1100. At time stamp C 1106, three aircraft are parked within the hangar 1100 with one aircraft exiting the hangar 1100 and one aircraft entering the hangar 1100. The difference in the amount of aircraft in the hangar 1100 at different time stamps illustrates the transitory nature of aircraft stored in a hangar space.

FIG. 12 is a top-down perspective diagram of a hangar 1200 with multiple parked aircraft 1202. Community Hangars can exceed 100% occupancy based on the total SF of all of the aircraft compared to the RSF of the hangar. A mathematical anomaly in commercial real estate management, an aircraft's SF 1204 is defined by its wingspan multiplied by its length, yet aircraft are regularly parked within the “shadow” of another aircraft. For example, the tail of one aircraft can overlap the wing of another aircraft. As a result, occupancy often exceeds 100%. The systems, apparatuses, and methods of this disclosure account for this anomaly.

As shown in FIG. 12, the RSF of the subject hangar is 27,040 SF (the length 1208 multiplied by the width 1206). However, using the ADD SF of the six aircraft shown in FIG. 12, some 38,916 SF is occupied, or 143% of the SF. As the system captures real-time occupancy of not only a user's hangar portfolio, but like or similar categorical hangars, a user can define “full” for each of its hangars using a number above 100%, unlike that of any other real estate management platform. Over time, historical occupancy metrics creates greater and greater data fidelity, allowing for predictive RSF availability, by using daily “Roll Call” data, calculated in FIG. 10. Hence, a user (or the system itself) can define “full” as any number between 0% occupancy, and the greatest occupancy level recorded, (143% in FIG. 12). This can be achieved by using the standardized ADD and ALD process disclosed herein.

FIG. 13 is an illustration of a map 1300 of an airport 1302 with various leaseholds 1304. The light-shaded boxes in FIG. 13 are examples of geofenced leaseholds at an example airport. Each of the leaseholds 1304 may contain multiple improvements, which may each contain multiple spaces.

FIG. 14 is an illustration of a map 1400 of an example leasehold 1404 at an airport 1402 with multiple improvements 1406. Improvements 1406 are numbered to correspond to either paved aircraft parking aprons 1408 or Hangars 1410. In this example, hangar improvements 1410 are depicted with numbers 1-4, whereas numbers 5-7 indicate designated paved aircraft parking aprons 1408 of the geofenced leasehold 1404.

Within each improvement 1406 are spaces, which are the physical locations within an improvement 1406. As shown in FIG. 14, the space numbered 6 may accommodate 6-10 aircraft, whereas the space numbered 7 may only accommodate 2 aircraft, each dependent upon the amount of square feet of each space, combined with the various aircraft sizes parked there, as defined in an ADD. Similarly, Hangars 1-4 have aircraft parking spaces within each hangar, also dependent upon the amount of square feet of each Hangar floor, combined with the various aircraft sizes parked within.

FIG. 15 is an illustration of a sample user interface 1500 demonstrating Roll Call data shown to a FBO in accordance with an illustrative embodiment. The user interface 1500 includes pertinent information for an aircraft user. The information can include the Tail No 1502 (the aircraft's registration number), the aircraft type 1504 (the make, and model of the aircraft), the type of customer in the hangar 1506, either a Transient or Based Tenant, the name of the customer who owns or operates the aircraft 1508, the aircraft's physical location within a hangar portfolio of multiple hangars 1510, the date and Time-In which the aircraft is positioned in the hangar space 1512, the status of the aircraft 1514, whether it is still located In Hangar, or the date and Time-Out the aircraft departed the hangar.

Additionally, the user interface 1500 can include a feature to delete the aircraft altogether once it has departed the leasehold 1516. If an aircraft is deleted, all historical data regarding the above is retained to provide complete historical information for insights and analytics.

FIG. 16 is an illustration of a sample user interface 1600 demonstrating insights and analytics for an FBO's storage facilities in accordance with an illustrative embodiment. The user interface 1600 can include the Roll Call data shown in FIG. 15 in addition to insights and analytics once sufficient data has been collected. In at least one preferred embodiment, the sample user interface 1600 is a BDS.

The user interface can display occupancy statistics for all hangars 1602 or for specific hangars 1604. To the right of the occupancy metrics, a seven-day rolling average of occupancy 1606 is depicted across all leaseholds in a bar graph, with vital statistics to the right 1608.

Notwithstanding the BDS view of analytics, commercial off-the-shelf data query platforms can be used to provide any manner of reporting and insights for an FBO, because of the data captured throughout the process.

FIG. 17 is an illustration of a block diagram of a system 1700 for reserving hangar spaces according to an illustrative embodiment. Generally, the system 1700 includes at least one electronic device 1702a-1702n (collectively 1702, where n represents any number of electronic devices) accessing an hangar booking server 1710 via a network 1708 to allow one or more users (e.g., aircraft customers (not shown)) to search for available hangar spaces in real-time and then book the spaces. In at least one embodiment, the system is a Transient Aircraft Hangar Marketplace (TAHM) that allows Transient Aircraft Operators (TAOs) to search for hangar spaces to store an aircraft without signing a lease.

Client device 1702, network 1708, AMS 1710, ADD 1714, ALD 1716, and third-party data provider 1718 can correspond to client device 202, network 208, AMS 210, ADD 214, ALD 216, and third-party data provider 218 respectively as shown in FIG. 2. Additionally, hangar booking server 1720 can be implemented with the same computing device as the AMS 1710. In other embodiments, hangar booking server 1720 is a separate server from the AMS 1710 that can exchange data with the AMS 1710 directly or via the network 1708.

In one embodiment, TAHM is a hangar reservation, booking, and payment platform used by TAO's to view available hangar space at a TAO's destination airport, nearby airports, and user defined geographic areas. Available hangar space to TAO's is offered by FBOs, hangar owners, airports, and others via TAHM, who can elect to publish their real-time, and/or predictive vacancies (unoccupied space). In some embodiments, one or more third-party data providers 1718 can supplement hangar vacancy data to the AMS 1710 via the network 1708. The methods and systems of this disclosure that identify available real-time available aircraft occupancy owned by FBOs offer the supply of available storage options for a TAO. TAHM is the reciprocal demand function platform for a TAO, allowing TAOs to reserve positive space at in a Hangar.

A TAO can access the TAHM on a client device 1702 via the network 1708, by using a computing device 500 in FIG. 5A, such as a desktop/laptop, or by a computing device 550 in FIG. 5B, such as a mobile phone. The TAHM can be implemented as a mobile application (Mobile App). Implementing the TAHM in accessible formats allow multiple types of users to reserve hangar spaces, such as TAOs who are planning a future trip, a scheduler or dispatcher associated with the TAO, or flight crew upon the TAO's arrival at a destination airport based on real-time availability.

A TAO can set up an account and create a user profile including the TAO's aircraft information, customer information, and payment type, among other details. This user data can be stored in the user aircraft database 1712. Other user-defined profile data may include, but is not limited to, frequented airports, “favorite” airports, and airports within a certain, user-defined geography of a destination. During profile creation, once a TAO's tail number is entered, it is recognized by the ADD 1714, assigned both the correct SF and RECAT, which is then used to “match” available, published improvements (hangar) at any airport in the ALD 1716, within the appropriate hangar categories for the RECAT of the aircraft, with sufficient RSF. If a TAO has both GPS and “push” notifications enabled, the TAHM can automatically provide (“push”) real-time hangar availability suitable to that TAO's aircraft, along with reservation details, such as hourly, daily, or nighty hangar pricing.

To reserve space in a hangar, a TAO can select the hangar from the list of appropriately categorized published available space, enter the number of hours, days or nights needed, and make payment. In at least one embodiment, the system 1700 presents the user interface 1800 in FIG. 18 to a TAO to reserve a hangar space. Upon payment, that hangar space is reserved, much like a hotel booking. The FBO or hangar operator who published the selected space can either confirm the reservation upon receiving a notification from the TAHM, or if having selected “automatic confirmation,” automatically confirm the reservation. In at least one embodiment, the “automatic confirmation” selection automatically confirms reservations provided the selected hangar has less than a pre-configured hangar occupancy threshold (e.g., 125% hangar occupancy).

Upon arrival at the destination airport with reserved hangar space, the TAO will “check in,” (again, similar to a hotel reservation process), and their aircraft is then placed into the reserved hangar space, and a Transient Roll Call record is created

While some embodiments of this disclosure refer to TAOs, certain embodiments can be designed by those of ordinary skill in the art to allow aircraft operators to search for and reserve hangar spaces by signing a lease.

FIG. 18 is an illustration of a sample user interface 1800 demonstrating a hangar reservation process in accordance with an illustrative embodiment. An aircraft customer, such as a TAO, can access the user interface 1800 using a computing device, such as devices 500 and 550 shown in FIGS. 5A and 5B respectively.

The user interface 1800 can present multiple options 1802 to an aircraft customer to find available hangars to store the customer's aircraft. In an illustrative embodiment, the customer is presented with the option of searching for hangars available to transient tenants or to leased tenants. Additionally, the customer can view a list of requested hangars the user has previously selected (not shown).

To search for available hangars, an aircraft customer first selects a location to center the search. In some embodiments, the user can select a place on a map as the location. In an illustrative embodiment, the user types in the name of the location in a search bar 1804. The user interface can then present a map 1812 of the location. In an illustrative embodiment, the map includes additional airports near the location and the time it takes to reposition the aircraft from those airports 1813.

The aircraft customer also selects an aircraft model to search for compatible hangars. In an illustrative embodiment, an aircraft customer can type in the aircraft model name in a search bar and be presented with options to select from 1806.

In addition, the aircraft customer selects what types of hangar spaces the customer wants to search for. In an illustrative embodiment, the customer is presented with checkbox options for parking an aircraft on a ramp, in a fully covered hangar, in a partially covered hangar, or in a private hangar 1808. The aircraft customer checks the boxes to select the hangar space types to include in the search.

Further, the aircraft customer selects a date range for when the customer wants to park the aircraft in the hangar spaces. In an illustrative embodiment, the user interface 1800 presents a date search bar where the customer has the option of typing in the beginning and ending dates, or selecting the dates from a calendar window after clicking a calendar icon.

After at least providing a type of aircraft, a location, and a date range, the user interface 1800 can present available hangars 1814 to the customer. In an illustrative embodiment, the hangars shown to the customer dynamically change in response to the customer selecting different parameters for the location 1804, the type of plane 1806, the hangar space type 1808, and the date range 1810. The user interface 1800 can use the systems and methods of the disclosure to receive available hangar options that are able to store the customer's aircraft.

The hangar options 1814 can present a short summary of the hangar space 1816 and one or more pictures of the hangar space 1818. In an illustrative embodiment, the summary can include information about the FBO, whether the hangar space is heated, the hangar space type, the number of available spaces, the nightly rate, or other identifiers. If the aircraft customer is searching for hangars available to lease, then the user interface 1800 may present a period rate to rent the hangar, the hours that the hangar is open, a call out fee to remove the aircraft from the hangar, or other fees set by the FBO. The customer can then select a hangar space option 1820 to reserve the hangar.

Various implementations of the methods, devices, systems, and techniques described here can be realized in digital electronic circuitry, integrated circuitry, specially designed ASICs (application-specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium”, and “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Although embodiments of the invention have been described with reference to several elements, any element described in the embodiments described herein are exemplary and can be omitted, substituted, added, combined, or rearranged as applicable to form new embodiments. A skilled person, upon reading the present specification, would recognize that such additional embodiments are effectively disclosed herein. Additionally, where an embodiment is described herein as comprising some element or group of elements, additional embodiments can consist essentially of or consist of the element or group of elements. Also, although the open-ended term “comprises” is generally used herein, additional embodiments can be formed by substituting the terms “consisting essentially of” or “consisting of.”

While this disclosure has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1.-20. (canceled)

21. A method for managing aircraft storage comprising:
capturing observation data of an aircraft on the ground, wherein the observation data comprises an aircraft registration number, further wherein geocode coordinates captured via a remote device are associated with the observation data;
storing, using one or more computer processors, observation data of an aircraft on the ground;
comparing, using the one or more computer processors, the stored observation data against an aircraft data set;
identifying, using the one or more computer processors, the aircraft based on the comparison;
determining, using the one or more computer processors, an area of the identified aircraft based on the aircraft data set;
comparing, using the one or more computer processors, the area of the identified aircraft with an available storage area of the identified leasehold, wherein the identified leasehold comprises an overall area defined by outer dimensions of the leasehold capable of storing one or more aircraft and a threshold area, and further wherein the threshold area exceeds the overall area;
determining, using the one or more computer processors, that the area of the identified aircraft can be added to the available storage area of the identified leasehold when the threshold area less an occupied area of the identified leasehold is greater than the area of the identified aircraft;
updating, using the one or more computer processors, a stored aircraft data set representing a list of aircraft present in the identified leasehold; and
providing, using the one or more computer processors, real-time information to a fixed base operator based on updated stored data.

22. The method of claim 21, further comprising, after identifying the aircraft, identifying a leasehold that is capable of storing the identified aircraft, wherein the observation data is compared against data stored in a database.

23. The method of claim 21, wherein the observation data is stored in an aircraft observation database (AOD), and wherein the observation data is captured via a sensor assembly.

24. The method of claim 23, wherein the step of identifying an aircraft based on the observation data further comprises comparing the observation data stored in the AOD with aircraft specification data stored in an aircraft details database (ADD).

25. The method of claim 24, wherein the ADD is automatically updated based on data from an aircraft specification data provider.

26. The method of claim 24, further comprising entering specifications about a leasehold and storing the specifications in an aircraft leasehold database (ALD).

27. The method of claim 26, wherein the leasehold specifications comprise the overall area of the leasehold, a door height of the leasehold, and a door width of the leasehold.

28. The method of claim 27, wherein the step of identifying a leasehold that can store the identified aircraft further comprises comparing the leasehold specifications stored in the ALD with the aircraft specification data stored in the ADD.

29. The method of claim 28, further comprising updating a hangar Roll Call by generating a record for the aircraft on the list of aircraft present in the hangar, wherein the record includes a registration number of the aircraft, the type of aircraft, the space the aircraft is added to, and the time the aircraft was added to the space.

30. The method of claim 21, wherein the step capturing observation data comprises the use of an Automatic Dependent Surveillance-Broadcast transponder equipped on the aircraft that transmits the aircraft's registration number and location to a radio receiver.

31. The method of claim 21, wherein the step of capturing observation data comprises scanning with a mobile reader a pre-configured code label fixed to the aircraft.

32. A system for managing aircraft storage, the system comprising:
a network;
one or more local data sources, wherein the one or more local data sources are operated or performed by a fixed-base operator (FBO) and are configured to capture observation data;
an aircraft management server (AMS), wherein the AMS comprises:
a communications interface that receives data from the network;
a memory storing instructions for automatically generating one or more aircraft entries based on aircraft data and presenting the one or more aircraft entries in a user interface; and
a processor communicatively coupled with the communications interface and the memory, and wherein the processor executes the instructions to:
identify one or more aircraft on the ground to be parked in a space owned or operated by the FBO;
determine a space in a leasehold capable of holding the one or more aircraft, wherein the processor determines whether adding the one or more aircraft would exceed a predetermined aircraft square footage occupancy threshold of a space;
assign a record on a list of aircraft parked in the hangar space for the one or more aircraft; and
present the record in a user interface;
wherein the AMS is configured to receive aircraft data from the one or more local data sources and one or more external data sources or methods; and
at least one electronic device configured to allow a user to access the user interface from the AMS via the network.

33. The system of claim 32, further comprising:
an aircraft observation database (AOD) configured to store aircraft observation data;
an aircraft details database (ADD) configured to store aircraft specification data; and
an aircraft leasehold database (ALD) configured to store leasehold specification data,
wherein the AOD, the ADD, and the ALD are configured to communicate with the AMS via the network.

34. The system of claim 33, wherein the ADD is automatically updated based on data from an aircraft specification data provider.

35. The system of claim 33, wherein the one or more local data sources comprises a sensor assembly configured to gather aircraft observation data of the one or more aircraft, and wherein the AMS is further configured to compare the aircraft observation data with the aircraft specification data to identify the one or more aircraft.

36. The system of claim 35, wherein the AMS is configured to automatically update the list of aircraft parked in the hangar at least once a day to establish which aircraft are parked overnight in a space by capturing observation data from one or more local data sources or methods.

37. The system of claim 33, further comprising one or more external data sources, wherein the one or more external data sources or methods are operated or performed by a third party and are configured to provide aircraft data, wherein the observation data is captured as digital data from one or more of an optical assembly and/or a wireless signal transmitter.

38. A system for assigning an aircraft to a storage space of a fixed-base operator (FBO), the system comprising:
a network;
one or more aircraft observation data sources comprising at least one of:
an Automatic Dependent Surveillance-Broadcast (ADS-B) transponder equipped on the aircraft configured to transmit the aircraft's registration number and the aircraft's location to a radio receiver;
one or more mobile devices operated by the FBO configured to scan a Quick Response (QR) code fixed on the exterior of the aircraft, wherein the QR code provides aircraft specification data when scanned; and
an optical character recognition (OCR) device configured to observe the aircraft's tail number, wherein the OCR device is positioned so as to observe aircraft entering or exiting the storage space;
wherein each of the one or more aircraft observation data sources is configured to transmit captured aircraft observation data to an aircraft management server (AMS) via the network;
one or more external aircraft specification providers, wherein each provider comprises an external server configured to transmit aircraft specifications to the AMS via the network;
the AMS comprising:
a communications interface that receives data from the network;
a memory storing instructions for automatically identifying one or more aircraft based on the aircraft data, determining a space in a leasehold capable of holding the one or more aircraft, assign a Roll Call record for the one or more aircraft, and present the Roll Call record in a user interface; and
a processor communicatively coupled with the communications interface and the memory, and wherein the processor executes the instructions to:
identify one or more aircraft on the ground by comparing the aircraft observation data with the aircraft specifications;
determine a space in a leasehold capable of holding the one or more aircraft, wherein the processor determines whether adding the one or more aircraft would exceed a predetermined aircraft square footage occupancy threshold of a space;
assign a record on a list of aircraft parked in the hangar space for the one or more aircraft; and
present the record in a user interface;
at least one electronic device configured to allow a user to access the user interface from the AMS via the network.

39. The system of claim 38, wherein the predetermined aircraft square footage occupancy threshold of a space exceeds 100%.

40. The system of claim 39, wherein the AMS is further configured to automatically predict the maximum aircraft square footage occupancy threshold of a space based on the greatest occupancy level recorded.
